(19) United States
(12) Patent Application Publication
(10) Pub. No.: US 2026/0147690 A1
(43) Pub. Date: May 28, 2026

(54) GENERATION OF TEST CODE VERSIONS WITH VARIANT-INJECTED CODE SECTIONS, FOR STATIC APPLICATION SECURITY TESTING

(71) Applicant: Micro Focus LLC, Wilmington, DE (US)

(72) Inventors: Alexander Michael Hoole, Waterloo (CA); Manish Marwah, Menlo Park, CA (US); Hari Manassery Koduvely, Ottawa (CA); Paula Branco, Ottawa (CA); Yansong Li, Ottawa (CA); Guy-Vincent Jourdan, Ottawa (CA)

(73) Assignee: Micro Focus LLC, Wilmington, DE (US)

(21) Appl. No.: 19/402,475

(22) Filed: Nov. 26, 2025

Related U.S. Application Data
(60) Provisional application No. 63/724,903, filed on Nov. 26, 2024.

(51) Int. Cl. G06F 11/362; G06F 8/71; G06F 21/57

(52) U.S. Cl. CPC G06F 11/362; G06F 8/71; G06F 21/577; G06F 2221/033

(57) ABSTRACT

A data flow graph and a control flow graph of each of a safe code section and an unsafe code section corresponding to the safe code section are extracted. Code variant-injected safe code sections corresponding to the safe code section and code variant-injected unsafe code sections, in which code semantics are not altered, are generated. Structurally modifiable code variant-injected code sections are generated based on the code variant-injected safe code sections, the code variant-injected unsafe code sections, and an impaired code section semantically uncorrelated to the code variant-injected safe code section and the code variant-injected unsafe code section. A version of test code is generated based on the structurally modifiable variant-injected code sections and a specified behavior.

### BACKGROUND

Computing devices like desktops, laptops, and other types of computers, as well as mobile computing devices like smartphones, among other types of computing devices, run software, which can be referred to as applications, to perform intended functionality. An application may be a so-called native application that runs on a computing device directly, or may be a web application or “app” at least partially run on a remote computing device accessible over a network, such as via a web browser running on a local computing device. An application can be tested, or analyzed, in a variety of different ways to ensure that the application correctly performs its intended functionality as well as to ensure that the application does not have any security vulnerabilities.

### BRIEF DESCRIPTION OF THE DRAWINGS

FIGS. 1A, 1B, and 1C are diagrams of example processes of one example implementation for generating test code having variant-injected code sections for static application security testing (SAST) purposes.

FIG. 1D is a diagram of an example process for using generated test code having variant-injected code sections to train and then use a generative artificial intelligence (AI) model for SAST.

FIG. 1E is a diagram of an example process for using generated test code having variant-injected code sections to generate and then use a benchmark for a SAST technique more generally.

FIGS. 2A and 2B are diagrams of example safe and unsafe code sections, respectively.

FIGS. 3A, 3B, and 3C are diagrams of example flow graphs of code sections. Specifically, FIGS. 3A and 3B are diagrams of data flow graphs of the safe and unsafe code sections of FIGS. 2A and 2B, respectively, whereas FIG. 3C is a diagram of an example control flow graph of the safe and unsafe code sections of FIGS. 2A and 2B.

FIGS. 4A, 4B, and 4C are diagrams showing example identification of potential areas of a code section in which variants can be injected. Specifically, FIGS. 4A and 4B are diagrams of respective control and data flow graphs of a code section showing potential areas where variants can be injected, and FIG. 4C is a diagram of an example index of these potential areas.

FIGS. 5A, 5B, 5C, and 5D are diagrams showing example narrowing down of the potential areas in which variants can be injected within a code section to those that do not result in semantic alteration upon injection. Specifically, FIG. 5A is a diagram of the control flow graph of FIG. 4A in which control chains have been identified during the narrowing-down process, and FIGS. 5B, 5C, and 5D are diagrams of the index of FIG. 4C during and after the narrowing-down process.

FIGS. 6A and 6B are diagrams showing example selection of target areas in which variants are to be injected while preserving semantic alternation, from the narrowed-down potential areas. Specifically, FIGS. 6A and 6B are diagrams of the index of FIG. 5D during and after selection.

FIGS. 7A and 7B are diagrams showing example injection of variants within the target areas a code section while preserving semantic alteration. Specifically, FIG. 7A is a diagram of a control flow graph of the code section upon variant injection, and FIG. 7B is a diagram of the variant-injected code section.

FIG. 8A is a diagram of an example flow graph for an example structurally modifiable outer code variant-injected code section. FIGS. 8B, 8C, and 8D are diagrams of the example structurally modifiable outer variant-injected code section.

FIG. 9A is a diagram of an example flow graph for an example structurally modifiable inner code variant-injected code section. FIGS. 9B, 9C, 9D, and 9E are diagrams of the example structurally modifiable inner variant-injected code section.

FIG. 10A is a diagram of an example flow graph for an example structurally modifiable inner-and-outer code variant-injected code section. FIGS. 10B, 10C, 10D, 10E, 10F, and 10G are diagrams of the example structurally modifiable inner-and-outer variant-injected code section.

FIGS. 11A, 11B, and 11C are diagrams of an example version of test code generated by structurally modifying a structurally modifiable outer variant-injected code section in accordance with a specified behavior.

FIG. 12 is a diagram of an example computing device.

### DETAILED DESCRIPTION

As noted in the background, an application can be tested to ensure that it performs its intended functionality as well as to ensure that it does not have any security vulnerabilities. One type of application testing that is performed, particularly to identify security vulnerabilities, is known as static application security testing (SAST). SAST can identify vulnerabilities including structure query language (SQL) injection, buffer overflow, and insecure application programming interface (API) usage, among others.

SAST involves analyzing the source code of an application to determine whether, upon generation of executable code from the source code, subsequent execution of the application will have security vulnerabilities. SAST is static in that the application is not actually executed to identify security vulnerabilities. That is, executable code for the application is not generated from the source code and/or is not executed. SAST utilizes just the source code of an application and does not consider the application when it is actually running.

SAST has traditionally been implemented via rule-based static analysis of an abstract syntax tree (AST) or other logical representation of source code. Such rule-based analysis is precise but brittle. Exclusively rule-based static analysis techniques are precise in that they can identify vulnerabilities for which their rules have been correctly written.

However, such techniques are brittle in a number of different ways. They may produce false positives and are not usually sufficiently generalized for application to new programming frameworks (e.g., function libraries) and new programming languages. Exclusively rule-based static analysis techniques may be unable to detect vulnerabilities that are not hardcoded into the rule sets. The rule sets can be quite voluminous and generally have to be manually constructed, which can require significant expenditures of time and which only security and/or coding experts may be able to do.

More recently, generative artificial intelligence (AI) models, such as large-language models (LLMs), have been employed to augment or replace rule-based analysis techniques for SAST. Such models are generative in that they create new content or data which resembles human-made output. More precisely, generative AI models learn the statistical patterns and structure of existing data, such as text, during training. The models then use the learned representations to generate new outputs that are not direct copies of but which are consistent with what has been learned.

However, the complexity of modern software can mask security vulnerabilities and complicate their detection via SAST when LLMs or other types of generative AI models are employed. Generative AI model-based SAST can suffer from testing biases, resulting in overlooked security vulnerabilities in source code due to the narrow scope of the test scenarios, or test cases, which the generative AI models have been trained on.

Merging safe code (i.e., source code that does not have security vulnerabilities) and unsafe code (i.e., source code that does have security vulnerabilities) in the same test case can be difficult without losing their semantic integrity. Code semantics refers to what the code means or does—i.e., its behavior or effect after compilation and subsequent execution. Similarly, generating additional test cases by structurally modifying existing test cases can affect their semantics.

Techniques described herein ameliorate these and other issues. The techniques provide for the generation of versions of test code that can then be used for different purposes such as evaluation of AI-based and non-AI-based SAST vulnerability detection approaches, comparison of different approaches through the creation of benchmark test suites (e.g., versions of test code), and for the improvement of AI-based SAST training. The techniques generate different test code versions by structurally modifying input test code via variant injection, in such a way that code semantics of the test code are not altered.

Subsequent usage of the trained model when performing SAST on target code (e.g., source code for an application that can be compiled and then executed) can result in improved identification of security vulnerabilities within the target code. Accordingly, security vulnerabilities may be more accurately detected and/or a greater number of at least similar security vulnerabilities may be able to be detected.

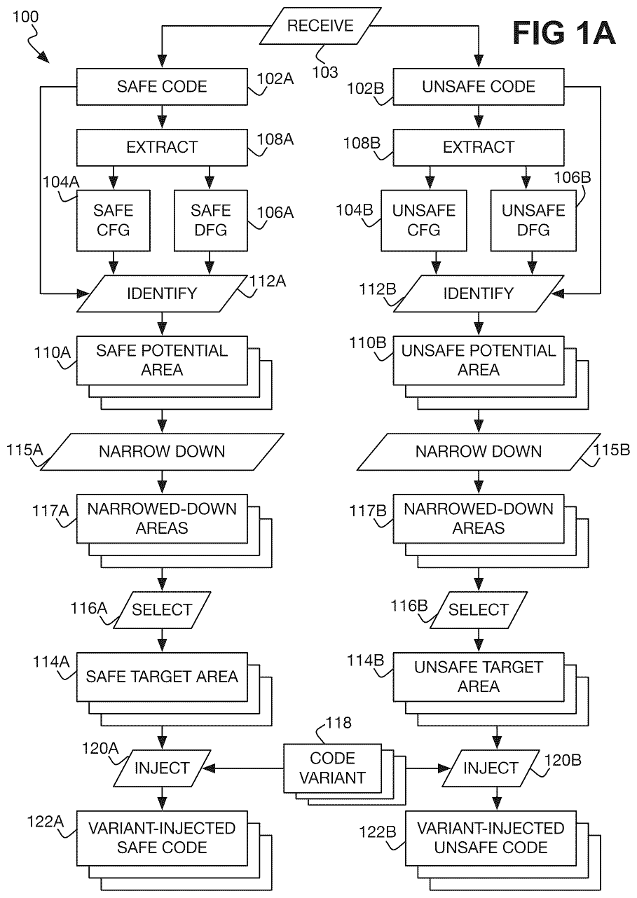

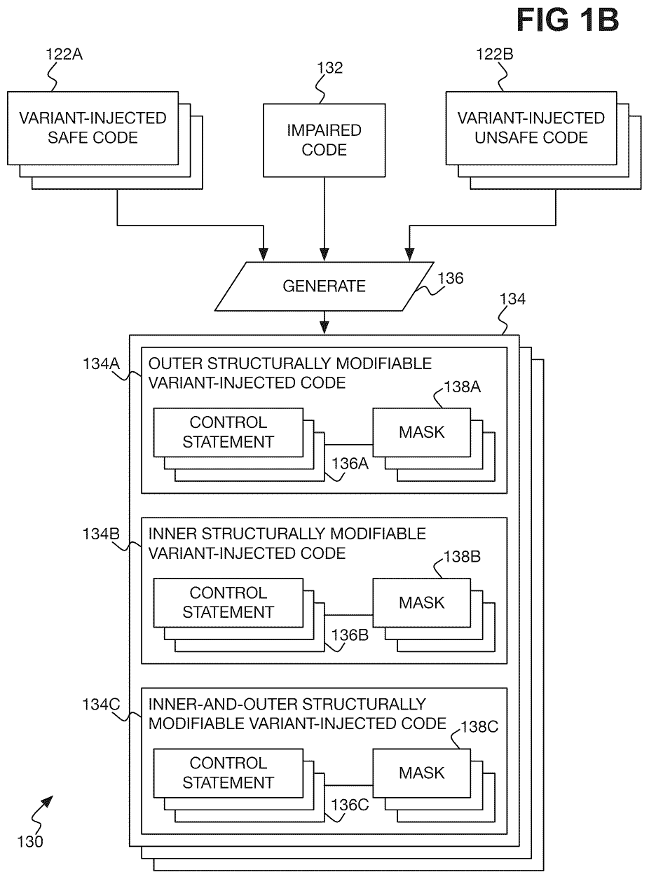

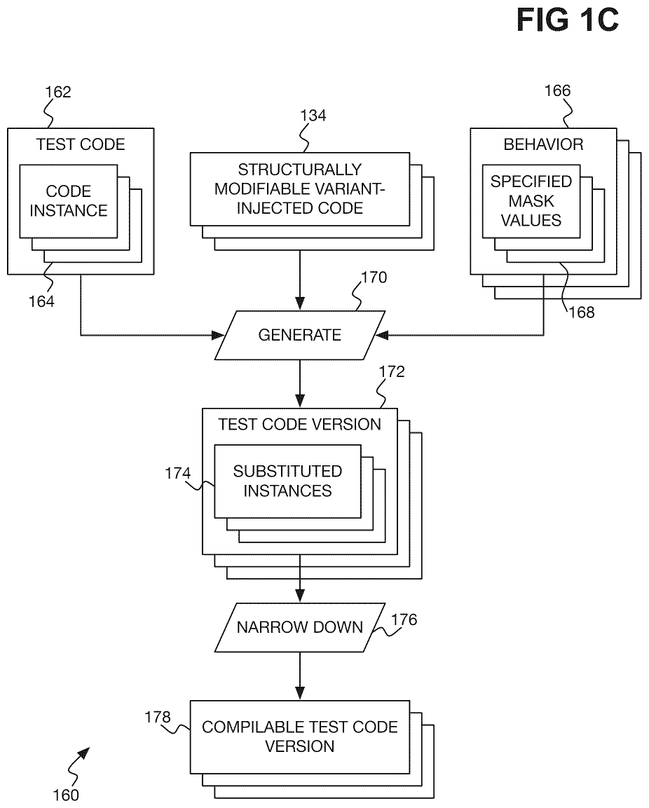

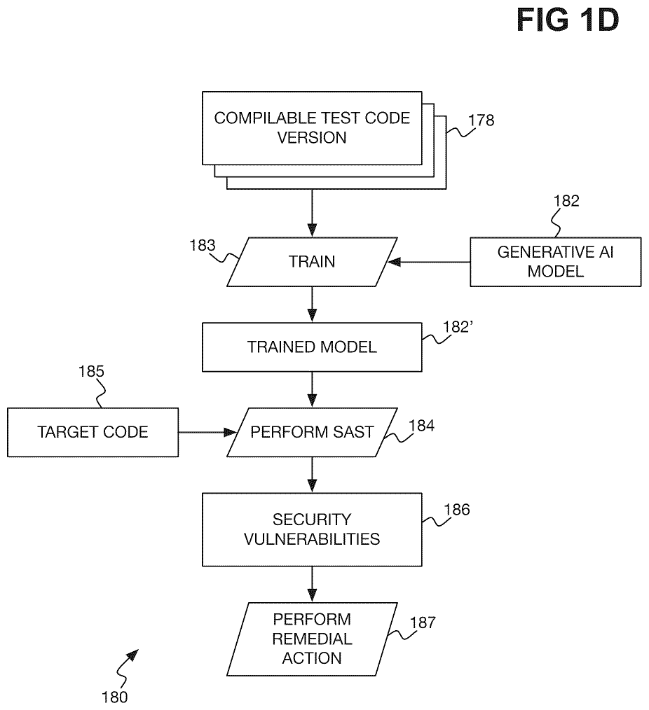

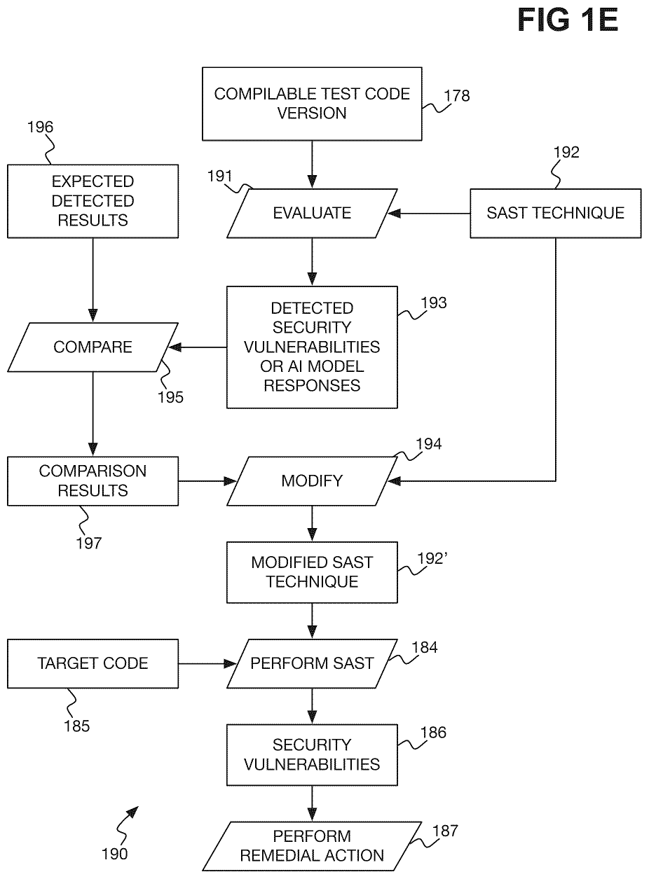

FIGS. 1A, 1B and 1C respectively show example processes 100, 130, and 160 of one example implementation for generating versions of test code having variant-injected code sections. The processes 100, 130, and 160 may be implemented as program code stored on a non-transitory computer-readable data storage medium, such as a memory, and executed by a processor of a computing device. The program code that may implement the processes 100, 130, and 160 is different than the test code referenced in these figures.

Referring to FIG. 1A, a safe code section 102A and an unsafe code section 102B are received (103) as input. The safe code section 102A is referred to as C_{safe}, whereas the unsafe code section 102B is referred to as C_{unsafe}. A given code section—i.e., either section 102A or 102B—can be referred to as C∈{C_{safe}, C_{unsafe}}.

The safe code section 102A and the unsafe code section 102B are sections in that they are not the complete code for an application, or other program, which can be compiled and then executed. Rather, the code sections 102A and 102B can each be a portion of code that can be included in the overall code of an application, a snippet of code that may be a self-contained example, and so on.

Both the code sections 102A and 102B are sections of source code. The unsafe code section 102B corresponds to the safe code section 102A. For instance, for a given safe section 102A for performing certain functionality, the corresponding unsafe section 102B performs the same functionality.

In one implementation, the safe section 102A is a source code section that does not include any security vulnerabilities, whereas the unsafe section 102B does include security vulnerabilities. The remainder of the detailed description pertains to this implementation.

However, in another implementation, the safe section 102A is a section of source code after patching (e.g., one that does not include vulnerabilities), and the unsafe code section 102B is the section prior to patching (i.e., section may include one or more vulnerabilities).

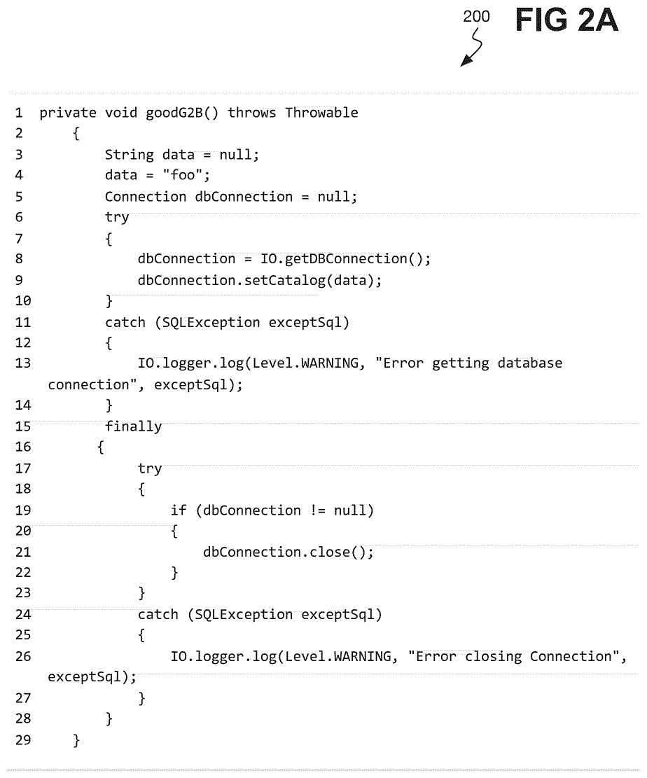

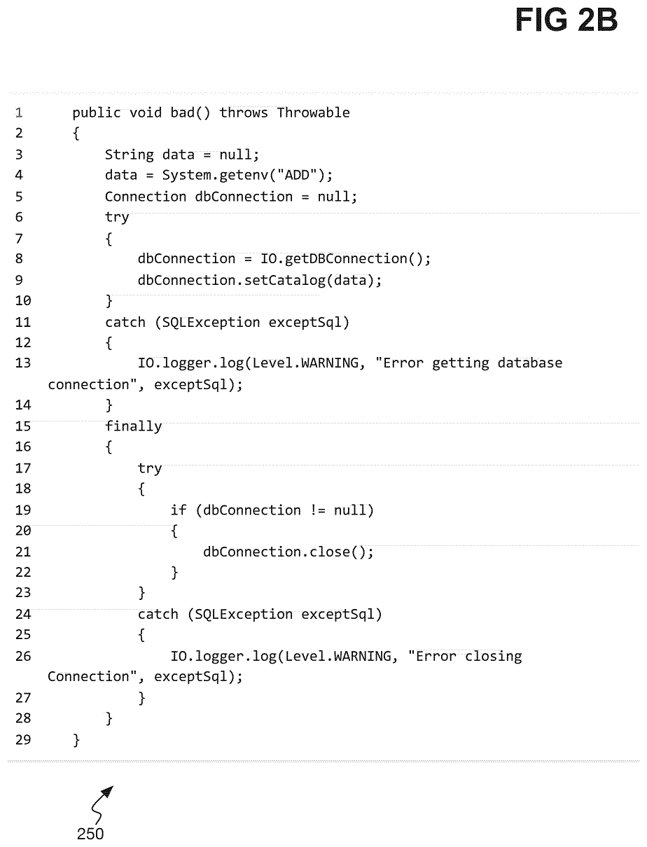

FIGS. 2A and 2B respectively show an example safe code section 200 and an example unsafe code section 250 corresponding to the safe code section 200. The safe section 200 does not have the common weakness enumeration (CWE) vulnerability identified as CWE-15 in the Juliet Java test suite available at github.com/UnitTestBot/juliet-java-test-suite, whereas the unsafe section 250 has this vulnerability. The sections 200 and 250 correspond to the examples provided in the Juliet test suite in CWE15_External_Control_of_System_or_Configuration_Setting_Environment_01.java.

The CWE-15 vulnerability is an external control of system or configuration setting vulnerability that permits untrusted input to modify a configuration. The safe section 200 does not have the CWE-15 vulnerability because the system settings code in line 9 uses a fixed system configuration value data locally defined in line 4, preventing external manipulation. By comparison, the unsafe section 250 does, because when setting the system configuration in line 9, a user-controlled value data is used per line 4.

Referring back to FIG. 1A, a control flow graph (CFG) 104A and a data flow graph (DFG) 106A are extracted (108A) from the safe code section 102A, and similarly a CFG 104B and a DFG 106B are extracted (108B) from the unsafe code section 102B. The graphs 104A and 106A are referred to as safe graphs because they are extracted from the safe code section 102A, and likewise the graphs 104B and 106B are referred to as unsafe graphs because they are extracted from the unsafe code section 102B.

A CFG represents how control advances through its respective code section. A CFG includes nodes of individual program statements or basic blocks of such statements without jumps, and includes edges of possible control transfers (e.g., after an if, loop, or function call) within the code section.

For a given code section Cᵢ, the CFG can be referred to as G_{c}={V_{c}, E_{c}}, where V_{c} is the set of all nodes v\hat{ }c in the CFG and E_{c} is the set of all edges e\hat{ }c in the CFG. Therefore, a given node i in the CFG can be referred to as vᵢ\hat{ }c∈V_{c}. An edge in the CFG between two nodes i and j can be referred to as e_{i,j}\hat{ }c∈E_{c}.

By comparison, a DFG represents how data moves and is transformed through its respective code section. A DFG includes nodes of operations or statements that produce or consume data (e.g., variables, expressions, inputs, and outputs), and includes edges of data dependencies that indicate how these operations feed into another.

For a given code section C, the DFG can be referred to as G_{d}={V_{d}, E_{d}}, where V_{d} is the set of all nodes v\hat{ }d in the DFG and E_{d} is the set of all edges e\hat{ }d in the DFG. Therefore, a given node i in the DFG can be referred to as vᵢ\hat{ }d∈V_{d}. An edge in the DFG between two nodes i and j can be referred to as e_{i,j}\hat{ }d∈E_{d}.

The safe CFG 104A and DFG 106A may be concurrently extracted from the safe code section 102A in (108A). Similarly, the unsafe CFG 104B and DFG 106B may be concurrently extracted from the unsafe code section 102B in (108B).

As an example, a given code section Cᵢ may first be parsed into an AST to extract syntactic code information. An example parser generator tool that may be used is Tree-sitter, available on the Internet at github.com/tree-sitter/tree-sitter.

A depth-first search may then be performed to traverse the AST to identify the nodes vᵢ\hat{ }d∈V_{d} and vᵢ\hat{ }c∈V_{c}. Concurrently, the edges e_{i,j}\hat{ }d∈E_{d} and e_{i,j}\hat{ }c∈E_{c} are identified when traversing from one node to another.

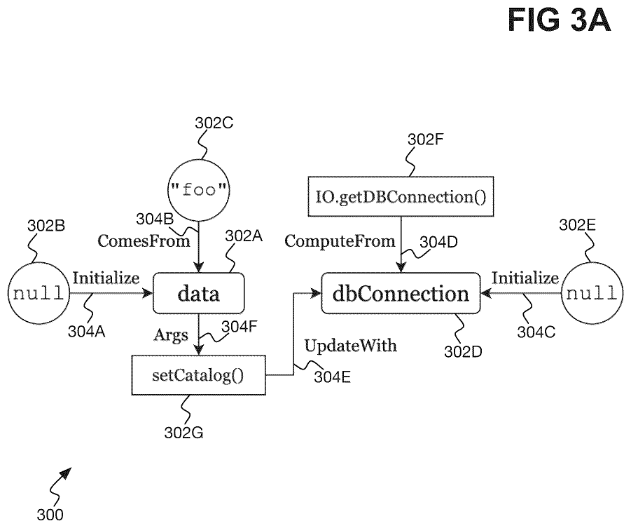

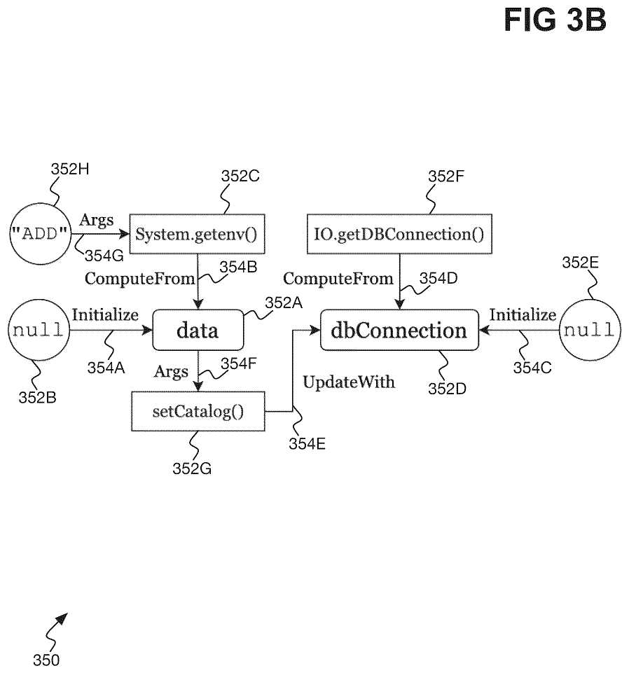

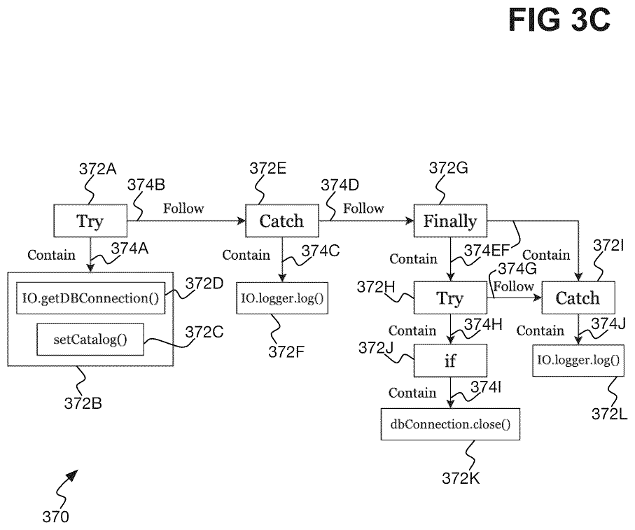

FIG. 3A shows an example DFG 300 for the safe code section 200 of FIG. 2A. The DFG 300 includes nodes 302A, 302B, 302C, 302D, 302E, 302F, and 302G, which are collectively referred to as the nodes 302. The DFG 300 includes edges 304A, 304B, 304C, 304D, 304E, and 304F, which are collectively referred to as the edges 304.

The node 302A corresponds to the variable data of type string in the safe code section 200, which is initialized with the null value of the node 302B via the edge 304A corresponding to line 3 of the safe section 200, and set to the string constant “foo” of the node 302C via the edge 304B corresponding to line 4 of the section 200.

The node 302D corresponds to the variable dbConnection of type Connection in the safe code section 200, which is initialized with the null value of the node 302E via the edge 304C corresponding to line 5 of the safe section 200, and set to the value provided by the function IO.getDBConnection( ) of the node 302F via the edge 304D corresponding to line 8.

The variable dbConnection of the node 302D is updated with the value provided by the function IO.setCatalog( ) of the node 302G via the edge 304E corresponding to line 9 of the safe code section 200. In particular, the function IO.setCatalog( ) of the node 302G is evaluated based on the variable data of the node 302A as an input argument passed to the function via the edge 304F which also corresponds to line 9.

FIG. 3B shows an example DFG 350 for the unsafe code section 250 of FIG. 2B. The DFG 350 includes nodes 352A, 352B, 352C, 352D, 352E, 352F, and 352G, which are collectively referred to as the nodes 352. The DFG 350 includes edges 354A, 354B, 354C, 354D, 354E, 354F, and 354G, which are collectively referred to as the edges 304.

The node 352A corresponds to the variable data of type string in the unsafe code section 250, which is initialized with the null value of the node 352B via the edge 354A corresponding to line 3 of the unsafe section 250, and set to the value provided by the function System.getenv( ) of the node 352C via the edge 354B corresponding to line 4. The function System.getenv( ) of the node 352C is evaluated based on the string constant “ADD” passed to the function via the edge 354G which also corresponds to line 4.

The node 352D corresponds to the variable dbConnection of type Connection in the unsafe code section 250, which is initialized with the null value of the node 352E via the edge 354C corresponding to line 5 of the unsafe section 250, and set to the value provided by the function IO.getDBConnection( ) of the node 352F via the edge 354D corresponding to line 8.

The variable dbConnection of the node 352D is updated with the value provided by the function IO.setCatalog( ) of the node 352G via the edge 354E corresponding to line 9 of the unsafe code section 250. The function IO.setCatalog( ) of the node 352G is evaluated based on the variable data of the node 352A as an input argument passed to the function via the edge 354F which also corresponds to line 9.

FIG. 3C shows an example CFG 370 for both the safe code section 200 of FIG. 2A and the unsafe code section 250 of FIG. 2B. The CFGs for safe and unsafe code sections are usually different. However, the particular safe and unsafe sections 200 and 250 in FIGS. 2A and 2B happen to have the same CFG 370.

The CFG 370 includes nodes 372A, 372B, 372C, 372D, 372E, 372F, 372G, 372H, 372I, 372J, 372K, and 372L, which are collectively referred to as the nodes 372. The CFG 370 includes edges 374A, 374B, 374C, 374D, 374EF, 374G, 374H, 374I, and 374J, which are collectively referred to as the edges 374.

The node 372A corresponds to the try statement defined at line 6 of the code sections 200 and 250, and per the edge 374A corresponding to the curly brackets of lines 7 and 10, includes a node 372B corresponding to the inside code block between lines 7 and 10. The node 372B contains the nodes 372C and 372D, where the node 372C corresponds to the IO.getDBConnection( ) statement in line 8 and the node 372D corresponds to the setCatalog( ) statement in line 9.

The node 372E follows the node 372A per the edge 374B within the CFG 370. The node 372E corresponds to the catch statement defined at line 11 of the code sections 200 and 250, and the edge 374B denotes that execution of the catch statement occurs if an exception is thrown during execution of the try statement in the sections 200 and 250. The node 372E contains the node 372F per the edge 374C corresponding to the curly brackets of lines 12 and 14. The node 372F corresponds to the IO.logger.log( ) statement in line 13.

The node 372G follows the node 372E within the CFG 370, per the edge 374D. The node 372G corresponds to the finally statement defined at line 15 of the code sections 200 and 250, and the edge 374D denotes that execution of the finally statement immediately follows execution of the try statement, or the catch statement if it is executed, in the sections 200 and 250. The node 372G contains the nodes 372H and 372I per the edge 374EF, which corresponds to the curly brackets of lines 16 and 28.

The node 372H corresponds to the try statement defined at line 17 of the code sections 200 and 250, and the node 372I corresponds to the catch statement defined at line 24. The node 372I follows the try node 372I within the CFG 370, per the edge 374G. The edge 374G denotes that execution of the catch statement occurs if an exception is thrown during execution of the try statement in the sections 200 and 250.

The node 372H contains the node 372J per the edge 374H, which corresponds to the curly brackets of lines 18 and 23. The node 372J corresponds to the if statement in line 19, and includes the node 372K per the edge 374I corresponding to the curly brackets of lines 20 and 22. The node 372K corresponds to the dbConnection.close( ) statement of line 21 that is performed if evaluation of the if statement in the node 372J is true.

The node 372I contains the node 372L per the edge 374J. The edge 374J corresponds to the curly brackets of lines 25 and 27 in the code sections 200 and 250. The node 372L corresponds to the IO.logger.lo( ) statement of line 26 in the sections 200 and 250.

Referring back to FIG. 1A, once the safe CFG 104A and the safe DFG 106A have been extracted in (108A), potential areas 110A within the safe code section 102A in which code variants 118 can be injected are identified (112A), based on the graphs 104A and 106A. The potential areas 110A can be referred to as safe potential areas because they are identified within the safe code section 102A.

In one implementation, and as particularly used in the remainder of the detailed description, the code variants 118 may be control flow-based variants—i.e., flow variants such as if-else, try-catch, or try-catch-finally statements. In another implementation, however, the code variants may be functional and/or structural variants. Examples of flow variants in particular include those described in “Juliet Test Suite v1.2 for Java User Guide” (2012), available at samate.nist.gov/SARD/downloads/documents/Juliet_Test_Suite_v1.2_for_Java_-_User_Guide.pdf.

Similarly, once the unsafe CFG 104B and the unsafe DFG 106B have been extracted in (108B), potential areas 110B within the unsafe code section 102B in which the code variants 118 can be injected are identified (112B) based on the graphs 104B and 106B. The potential areas 110B are referred to as unsafe potential areas because they are identified within the unsafe code section 102B.

As noted above, a code variant 118 can be a control flow-based variant, and is a syntactically valid code fragment that introduces additional control flow branches to the code section 102A or 102B in question. In this case, a code variant 118 is a control flow path through which a security vulnerability may or may not be manifested. There may be multiple code variants 118 for a given vulnerability, such as a given CWE vulnerability, where each variant 118 represents a different way that the vulnerability can be realized. The set of all code variants 118 may thus include multiple variants for each of multiple vulnerabilities.

Potential areas of a code section in which a code variant 118 can be injected include assignment statements, regions both within and outside existing control statements, and locations around function blocks. The areas are considered potential areas in that the variant 118 will not necessarily be injected in them, but only that the variant 118 could be injected in them.

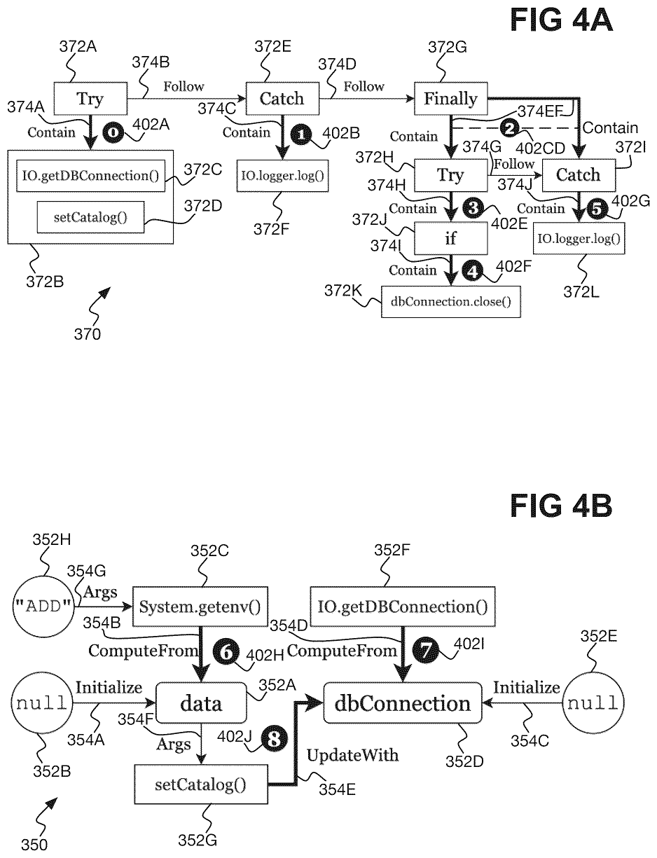

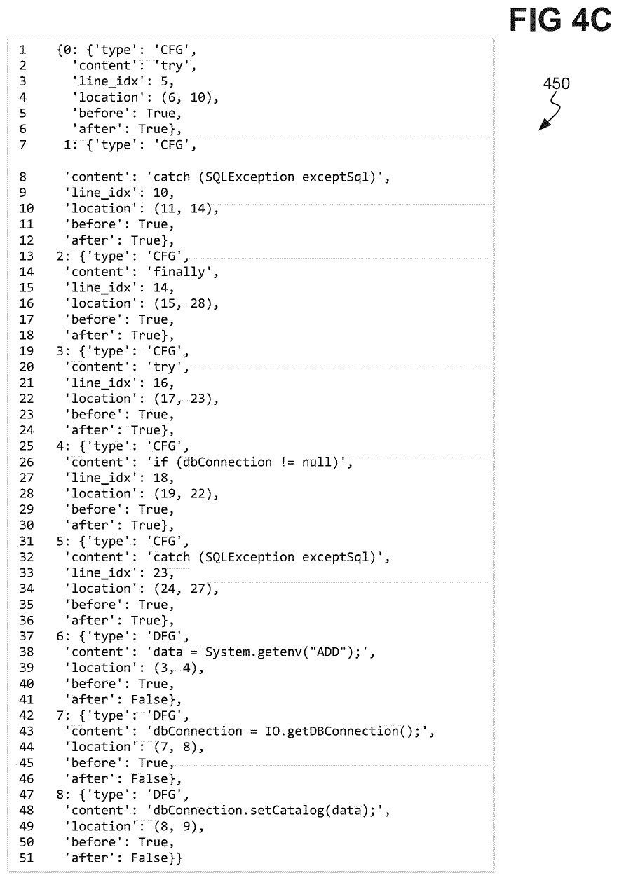

FIGS. 4A, 4B, and 4C show how potential areas within the unsafe code section 250 of FIG. 2B for variant injection can be identified in (112B) of FIG. 1A, as a particular example. Identification of potential areas within the safe code section 200 of FIG. 2A for injection in (112A) is similar.

FIGS. 4A and 4B respectively show the CFG 370 of FIG. 3C and the DFG 350 of FIG. 3B of the unsafe section 250. FIG. 4A specifically shows, in relation to the CFG 370, potential areas 402A, 402B, 402CD, 402E, 402F, and 402G in which code variants can plausibly be injected in the code section 250. The areas 402A, 402B, 402CD, 402E, 402F, and 402G are designated as areas 0, 1, 2, 3, 4, and 5 in the figure, respectively. The areas 402A, 402B, 402CD, 402E, 402F, and 402G are located at edges 374A, 374C, 374EF, 374H, 374I, and 374J of the CFG 370, respectively.

FIG. 4B specifically shows, in relation to the DFG 350, potential areas 402H, 402I, and 402J in which variants can plausibly be injected in the code section 250. The areas 402H, 402I, and 402J are respectively designated as areas 6, 7, and 8 in the figure, and are respectively located at edges 354B, 354D, and 354F of the DFG 350. The areas 402A, 402B, 402CD, 402E, 402F, and 402G of FIG. 4A and the areas 402H, 402I, and 402J of FIG. 4B are collectively referred to as the areas 402.

The areas 402 can be plausibly injected with variants because they are plausible locations in which control-flow injections will not alter code behavior or render the resulting code uncompilable. That is, the areas do not disrupt original control flow or change code semantics. The other, unmarked locations are not plausibly injectable because they are variable initializations or already part of an existing control-flow chain. Injecting new control flow could break existing structure or render the resulting code uncompilable.

FIG. 4C is a diagram of an example index 450 of the potential areas 402 in which code variants can plausibly be injected in the code section 250. As noted above, the areas 402A, 402B, 402CD, 402E, 402F, 402G, 402H, 402I, and 402J respectively correspond to areas 0, 1, 2, 3, 4, 5, 6, 7, and 8 in FIGS. 4A and 4B. These areas 0, 1, 2, 3, 4, 5, 6, 7, and 8 respectively correspond to lines 1-6, 7-12, 13-18, 19-24, 25-30, 31-36, 37-41, 42-46, and 47-51 in the index 450 of FIG. 4C.

The lines for each of the areas 0-8 include the following information. The type indicates whether the area pertains to the DFG or the CFG, the content provides the corresponding statement in the code section 250 for that area, and line_index identifies the corresponding line for this statement in the code section 250. The line_index is 0-based, such that the statement in question is located at line (line_index+1) in the code section 250. For example, the area 0 is in the CFG 370 and corresponds to the try statement at line 5+1=6 in the code section 250.

The location refers to the region influenced by the DFG or the CFG in question. The influenced region is specified as a range of lines in the code section 250. For example, for area 0, the CFG 370 is influenced by the region corresponding to lines 6 through 10 in the code section 250. The influenced region is the portion of the code section 250 that is affected by or pertains to the statement corresponding to the area. For area 0, the try statement in line 6 in the code section 250 pertains to the code block between lines 7 and 10.

The information before and after indicates whether the code variant should be injected before and thus outside the code block corresponding to the influenced region (i.e., before line 6), within the code block (i.e., after line 7 and before line 10), or both before and within the code block, using the values true and false. For example, for area 0, both before and after are true. Therefore, the variant can be plausibly injected before line 6 in the code section 250 as well as after line 7 and before line 10 in the code section 250.

Referring back to FIG. 1A, the potential areas 110A within the safe code section 102A are narrowed down (115A) to yield just those narrowed-down areas 117A that if injected with a given code variant 118 would not alter the semantics of the overall safe section 102A. The potential areas 110B within the unsafe code section 102B are similarly narrowed down (115B) to yield just those narrowed-down areas 117B that if injected with the variant 118 in question would not semantically modify the unsafe section 102B as a whole.

Narrowing down of a given code section Cᵢ may, for instance, be achieved by applying a logical filter based on the sets of existing control statements corresponding to the edges E_{c} of the CFG G_{c} for the code section Cᵢ to prevent injections that could semantically alter the section Cᵢ. For example, an extraneous “if” control statement would not be injected within an existing “if-else” structure.

A logical filter can be considered a programmatic mechanism that identifies where control-flow injection is permitted to prohibited. The filter may be generated by first extracting all existing control-flow structures in the code, such as if-else, switch, try-catch-finally, and so on. The control-flow sub-chains (i.e., catch or finally within try-catch-finally) are enumerated and statements that are structurally connected are marked. If a statement is part of a connection chain, the filter flags the region as non-insertable, because inserting new control flow would break the existing chain. The result is a set of markers that specify which locations are injectable and which are not.

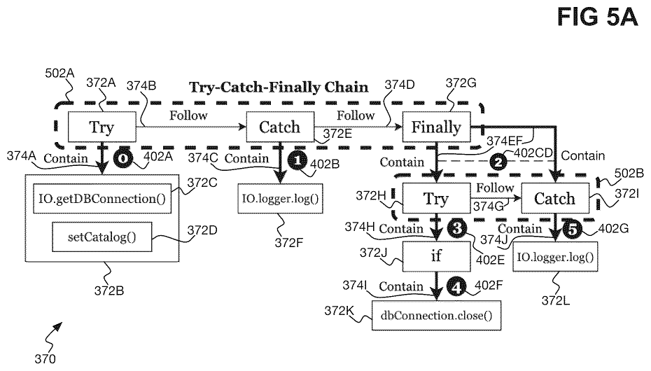

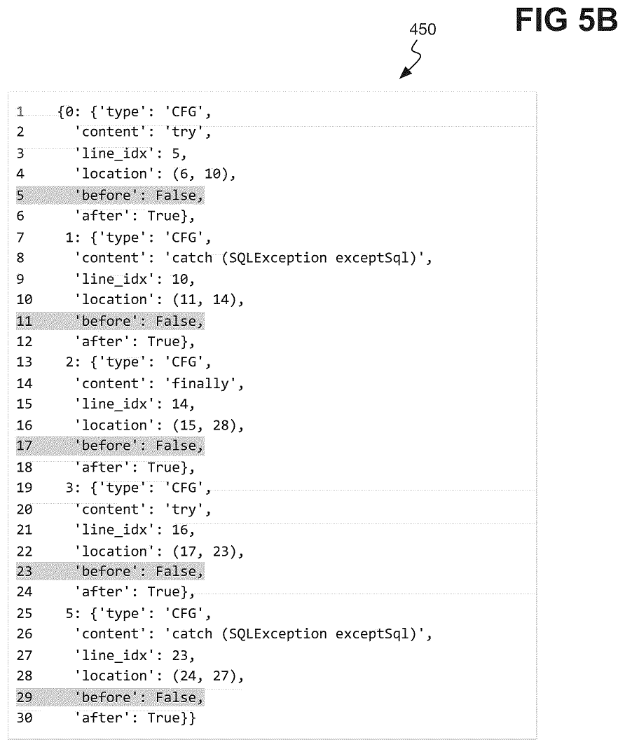

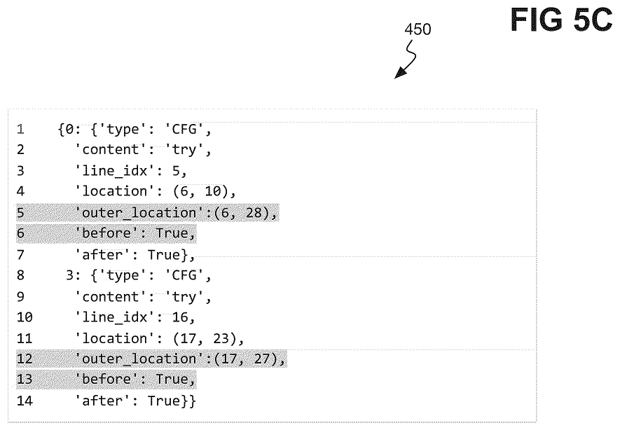

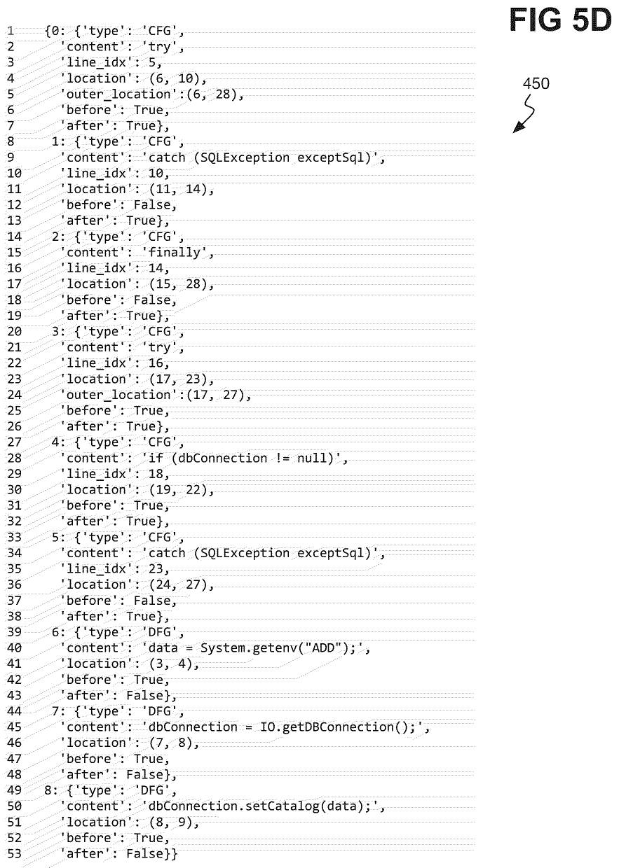

FIGS. 5A, 5B, 5C and 5D are diagrams showing example narrowing down of the potential areas within the unsafe code section 250 of FIG. 2B in (115B) in FIG. 1A, to just the areas that do not result in semantic alteration of the section 250 when injected, as a particular example. Narrowing down of the potential areas within the code section 200 of FIG. 2B in (115A) is similar.

FIG. 5A specifically shows the CFG 370 of FIG. 3C of the unsafe section 250, with the potential areas 402A, 402B, 402CD, 402E, 402F, and 402G designated as in FIG. 4A. Narrowing down the areas 402A, 402B, 402CD, 402E, 402F, and 402G to just those which do not semantically alter the code section 250 when injected with a code variant includes identifying control chains within the CFG 370 that are inseparable.

Example inseparable control chains include try-catch constructs, if-else constructs, if-else ladder constructs, switch-case-default constructs, loop headers with associated bodies (i.e., for, while, and do-while), and so on. In the Java programming language, for instance, additional control chains may include try-with-resource constructs that have all catch catch/finally blocks and synchronized blocks. In the C programming language, by comparison, additional control chains may include label-goto pairs.

Inserting code variants within these chains could cause compilation errors or semantic code alteration. In the CFG 370, there are two chains: a try-catch-finally chain 502A and a try-catch chain 502B, which are collectively referred to as the chains 502. Therefore, the areas 402A, 402B, 402CD, 402E, 402F, and 402G are narrowed down so that variants are not injected within the chains 502. Specifically, area 402F is removed from consideration because just the other areas 402A, 402B, 402CD, 402E, and 402G are identified during the narrowing down process.

FIG. 5B shows a portion of the index 450 after the areas 402A, 402B, 402CD, 402E, 402F, and 402G have been narrowed down so that variants are not injected within the chains 502 in the CFG 370. The information (i.e., selector status) before or after is changed from true to false for each area as appropriate so that a code variant is not injected if it would result in semantic alteration. In the example, the selector status before is specifically changed from true to false for each area; note that this is with reference to the CFG 370, because the DFGs 300 and 350 are not impacted. This is because injecting a variant before the block could potentially alter code semantics of the code section 250 at execution, since the area is located within the chain 502A or 502B that is not to be internally altered.

Since inseparable chains cannot have code variants injected in them, the narrowing-down process also includes wrapping each such chain with an outer code block. This is achieved by indicating the location of the code block within the code section 250 in relation to its head or initial statement in the index 450, and resetting the corresponding before information in the index 450 from false back to true.

In the CFG 370 of FIG. 5A, for instance, the chains 502A and 502B, which have head statements in nodes 372A and 372H, respectively, are each wrapped with a code block. The location of each code block is indicated in relation to its head statement in the index 450 of FIG. 5B, and its corresponding before information is likewise reset in the index 450 from false back to true.

FIG. 5C shows a portion of the index 450 of FIG. 5B upon being updated in this manner. Lines 1-7 correspond to lines 1-6 of the index 450 in FIG. 5B, and lines 8-14 correspond to lines 19-24 of the index 450 in FIG. 5B. The outer-location information in line 5 has been added for the head try statement of the chain 502A. The outer-location information indicates that the code block between lines 6 and 28 of the code section 250 of FIG. 2B is wrapped. The before information in line 6 in FIG. 5C (i.e., line 5 in FIG. 5B) has been reset back to true.

Similarly, the outer-location information in line 12 has been added for the head try statement of the chain 502B. The outer-location information indicates that the code block between lines 17 and 27 of the code section 250 of FIG. 2B is wrapped. The before information in line 13 (i.e., line 23 in FIG. 5B) has been reset back to true. It is noted that adding the outer_location information and setting the before information back to true does not affect the after information. That is, the outer_location and the before information for a try block covers the entire try-catch-finally or try-catch structure, whereas the after information refers to the block within the try statement.

FIG. 5D shows a portion of the index 450 of FIG. 4C after the index 450 has been updated per FIGS. 5B and 5C. That is, the before information for the areas 402A, 402B, 402CD, 402E, 402F, 402G, 402H, 402I, and 402J in the index 450 are initially set to false per FIG. 5B. Then, the outer-location information for the areas 402A and 402E is added to the index 450, and the before information for the areas 402A and 402E is reset back to true in the index 450, per FIG. 5C.

Referring back to FIG. 1A, target areas 114A within the safe code section 102A that are to be considered for injection with the variants 118 are selected (116A) from the narrowed-down areas 117A. Similarly, target areas 114B within the unsafe code section 102B to considered for injection with the variants 118 are selected (116B) from the narrowed-down areas 117B.

The target areas 114A are referred to as safe target areas because they are located within the safe section 102A, and the target areas 114B are referred to as unsafe target areas because they are located within the unsafe section 102B. The target areas 114A and 114B may be randomly selected from their respective narrowed-down areas 117A and 117B, or in another manner. Other example selection techniques include Bayesian model selection techniques, heuristic selection techniques, differential robustness, and so on.

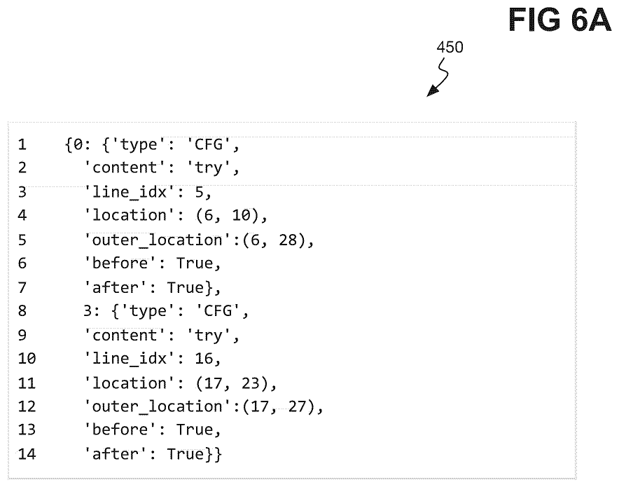

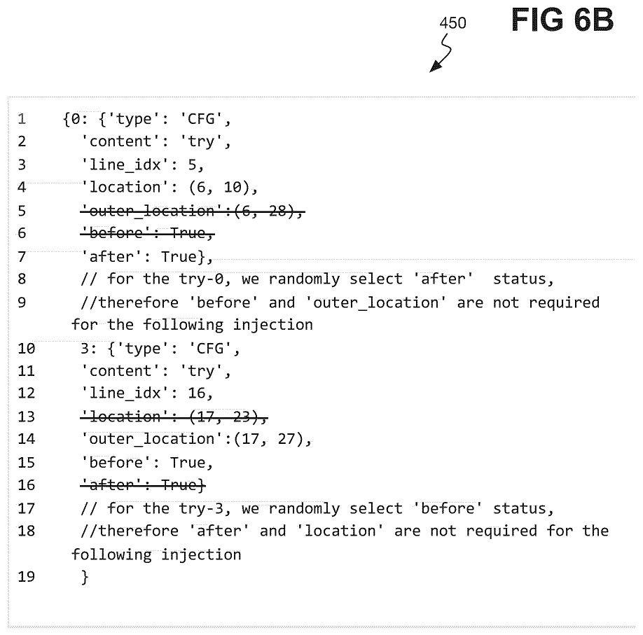

FIGS. 6A and 6B show how target areas within the unsafe code section 250 of FIG. 2B in which code variants are to actually be injected can be randomly selected in (116B) of FIG. 1A, as a particular example. Selection of target areas within the safe code section 200 of FIG. 2A in (116A) of FIG. 1A is similar.

The target areas can be randomly selected from the narrowed-down areas by a two-step process. First, N areas may be randomly selected from the narrowed-down areas. This step can be referred to as position sampling. Second, for each randomly selected N area, if the before and after information true are both true, then either the before or after location is selected for that area.

If just one of them is true, then the corresponding location is selected for the area in question (e.g., if just the after information is true, then just the after location is selected). If neither of them is true, then a different area is randomly selected to replace it and the second step repeated. The second step can be referred to as status sampling.

FIG. 6A shows a portion of the index 450 of FIG. 5D after example performance of the first, position sampling step. Specifically, in the example, two areas—the areas 402A and 402E in FIG. 4B—have been selected. Lines 1-7 of FIG. 6A correspond to the area 402A and are identical to lines 1-7 of FIG. 5D, and lines 8-14 correspond to the area 402E and are identical to 20-26 of FIG. 5D.

FIG. 6B shows this portion of the index 450 of FIG. 5B after example performance of the second, status sampling step. Lines 1-9 correspond to the area 402A and thus to lines 1-7 of FIG. 6A. Lines 10-19 correspond to the area 402E and thus to lines 20-26 of FIG. 6A.

The before and after information for the area 402A in lines 6 and 7 of FIG. 6A are both true, and therefore either the before location or the after location is randomly selected. In FIG. 6B, the after location has been randomly selected; accordingly, lines 5 and 6 have been crossed out, per the added comment line 8.

Similarly, the before and after information for the area 402B in lines 13 and 16 of FIG. 6A are both true, and likewise either the before location or the after location is randomly selected. In FIG. 6B, the before has been randomly selected; accordingly, lines 13 and 17 have been crossed out, per the added comment lines 17 and 18.

Referring back to FIG. 1A, one or more of the code variants 118 are then injected (120A) in each target area 114A that has been selected within the safe code section 102A, yielding code variant-injected safe code sections 122A that can each be referred to as C′_{safe}. In an example implementation to which the rest of the detailed description pertains, one of the code variants 118 is randomly selected for each target area 114A. The same or different variant 118 may be injected into each area 114A. In another implementation, by comparison, each variant 118 may be injected into each area 114A.

The semantics of the safe section 102A are not altered in each variant-injected safe section 122A. This is because the target areas 114A were selected in (116A) after narrowing down the potential areas 110A in (115A) to just those areas 117A that when injected with a variant 118 would not semantically modify the safe section 102A.

Similarly, one or more code variants 118 are injected (120B) in each target area 114B that has been selected within the unsafe code section 102B, yielding code variant-injected unsafe code sections 122B that can each be referred to as C′_{unsafe}. The semantics of the unsafe section 102B are also not altered in each variant-injected unsafe section 122B. This is because the target areas 114B were selected in (116B) after narrowing down the potential areas 110B in (115B) to just those areas 117B that when injected with a code variant 118 would not semantically modify the unsafe section 102B.

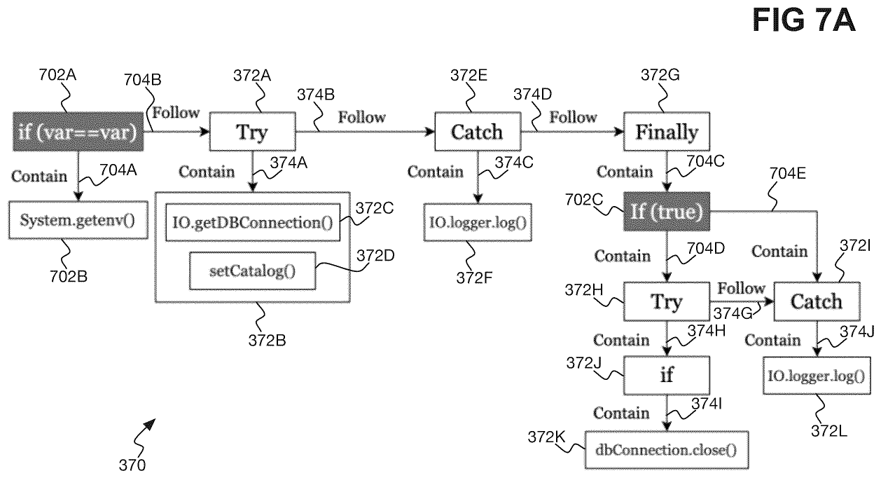

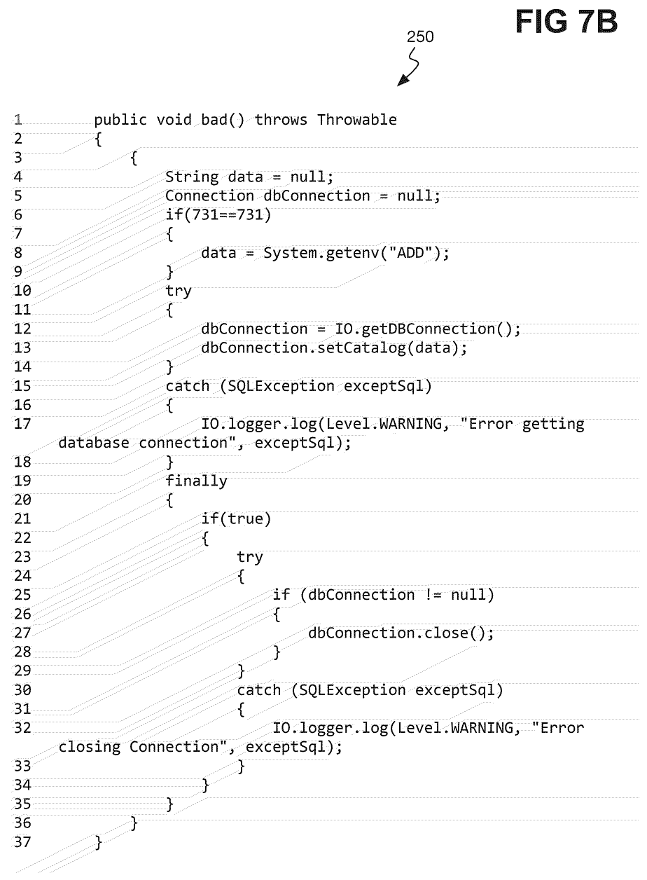

FIGS. 7A and 7B show how the selected target areas within the unsafe code section 250 of FIG. 2B can have code variants injected in them in (120B) of FIG. 1A, as a particular example. Variant injection in selected target areas within the safe code section 200 of FIG. 2A in (120A) is similar.

FIG. 7A specifically shows the CFG 370 of FIG. 3C of the unsafe code section 250 after variants have been injected per the index 450 of FIG. 6B. The CFG 370 of FIG. 7A is the CFG 370 of FIG. 3C with two differences. First, nodes 702A, 702B, and 702C and edges 704A, 704B, 704C, 704D, and 704E have been added. Second, the edges 374EF of FIG. 3C have been removed in FIG. 7A.

A first injected variant includes the nodes 702A and 702B, as well as the edge 704A indicating that the node 702A contains the node 702B. The first variant is injected before the try-catch-finally chain 502A of FIG. 5A, such that the node 372A follows the node 702A in the chain 502A per the edge 704B. The node 702A corresponds to the statement “if (var)==(var)”, and the node 702B corresponds to the statement “System.getenv( )”. This means try-catch-finally chain 502 and also covers the corresponding data flow within the same block.

A second injected variant is injected before the try-catch chain 502B of FIG. 5A. This variant includes the node 702C, which corresponds to the statement “if (true)”. This means that the variant spans the entire try-catch chain 502B and also covers the computations and/or data assignments within it, such as IO.logger.log( ). The node 372C contains the node 702C in FIG. 7A per the edge 704C. The nodes 372H and 372I that previously were directly contained by the node 372G per the edge 374EF in FIG. 5A are now contained by the node 702C per the edges 704D and 704E in FIG. 7A.

FIG. 7B shows the variant-injected code section 250 of FIG. 2B corresponding to the CFG 370 of FIG. 7A. Lines 6 and 8 respectively correspond to the nodes 702A and 702B of the first variant, and the curly brackets of lines 7 and 9 correspond to the edge 704A of FIG. 7A. Line 21 corresponds to the node 702C of the second variant, and the curly brackets of lines 22 and 34 correspond to the edges 704D and 704E of FIG. 7A.

Referring next to FIG. 1B, which is performed after FIG. 1A, what are referred to as structurally modifiable variant-injected code sections 134 are generated (136). The sections 134 are generated based on (e.g., from) the safe variant-injected code section 122A, the unsafe variant-injected code sections 122B, and an impaired code section 132. The impaired code section 132 is artificially generated code that is semantically uncorrelated to each variant-injected section 122A and 122B.

The structurally modifiable variant-injected code sections 134 can be generated (136) by first detecting additions, deletions, and modifications between the safe variant-injected section 122A and the unsafe variant-injected section 122B for each safe and unsafe variant-injected section pair. For example, a sequence matcher may be employed to detect such additions, deletions, and modifications, such as the Python sequence matcher described at docs.python.org/3/library/difflib.html.

The structurally modifiable variant-injected code section 134A is referred to as an outer such section which alters code behavior by inserting control statements 136A outside differing corresponding segments of the sections 122B and 122A that are semantically distinct, and the impaired code section 132 in respective blocks. The control statements 136A permit selection of segments of respective sections 122A, 122B, and 134 via corresponding masks 138A.

For example, a first control statement outside the segment of the variant-injected unsafe section 122B permits selection of the section 122B via a first mask. A second control statement outside the segment of the variant-injected safe section 122A permits selection of the section 122A via a second mask. A third control statement outside the segment of the impaired section 132 permits selection of the section 132 via a third mask.

The structurally modifiable variant-injected code section 134B is referred to as an inner such section because it internally alters the code. Specifically, code behavior is altered by inserting control statements 136B to select a segment in the section 122B that has a corresponding but different segment in the section 122A, the corresponding segment of the section 122A, or the section 132 inside the code section. The control statements 136B permit such selection via corresponding masks 138B.

For example, a fourth control statement permits selection of the segment of the variant-injected unsafe section 122B via a fourth mask. A fifth control statement permits selection of the corresponding, differing segment of the variant-injected safe section 122A via a fifth mask. A sixth control statement permits selection of the impaired section 132.

The structurally modifiable variant-injected code section 134C is referred to as an inner-and-outer such section, which alters code behavior by inserting control statements 136C inside and/or outside the differing corresponding segments of the sections 122B, 122A, and 132. The control statements 136C permit selection of respective sections 122A, 122B, and 134 via corresponding masks 138C.

For example, a seventh control statement outside a structurally modifiable inner code variant-injected code section permits selection of this inner section of this section via a seventh mask. The inner section can be the inner section 134B, and therefore include the described fourth, fifth, and statement masks. An eighth control statement outside the variant-injected unsafe section 122A permits selection of the section 122A via an eighth mask. A ninth control statement outside the segment of the impaired section 132 permits selection of the section 132 via a ninth mask.

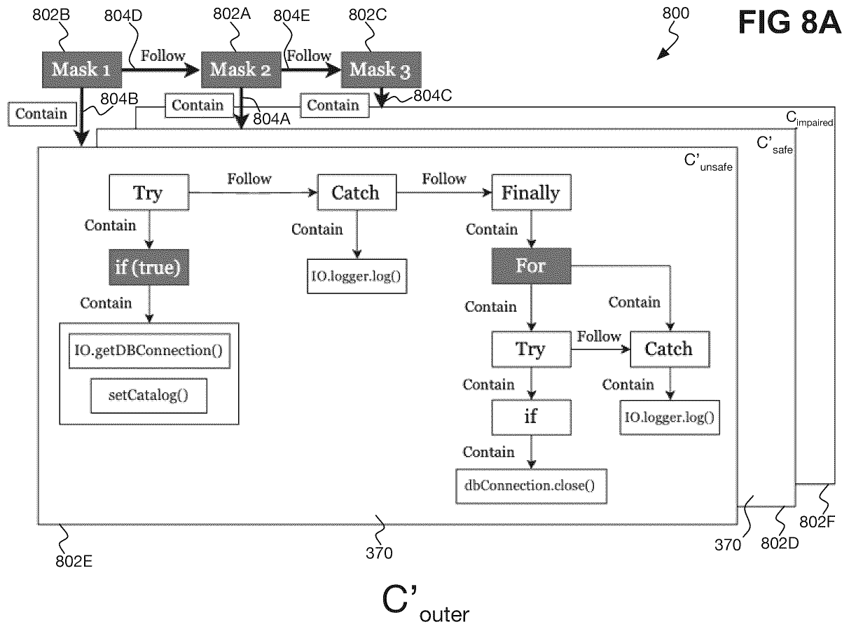

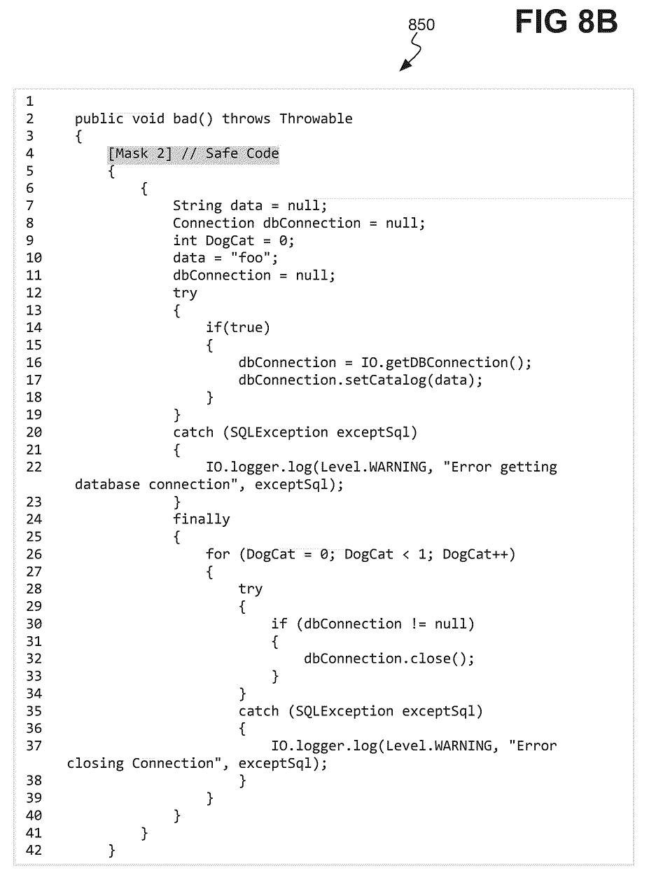

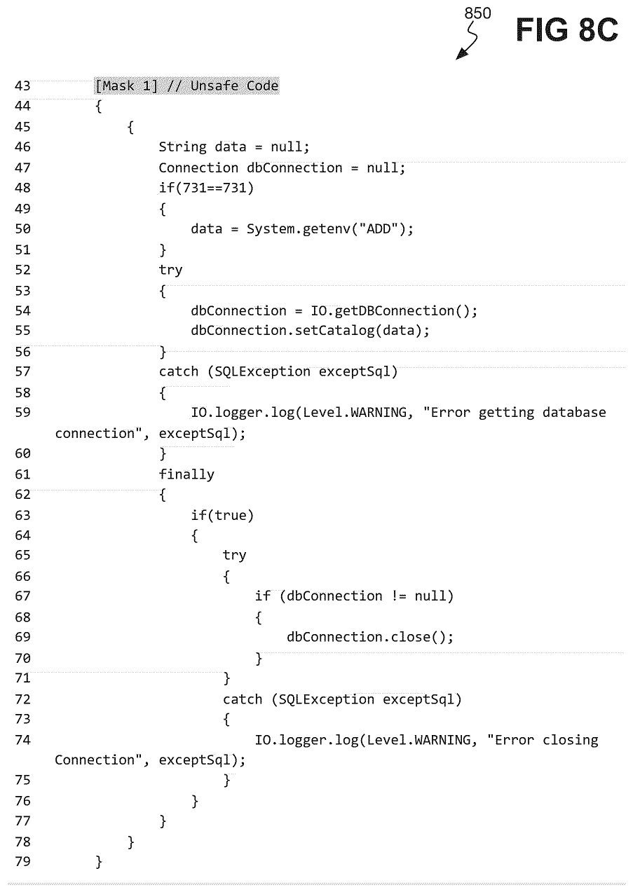

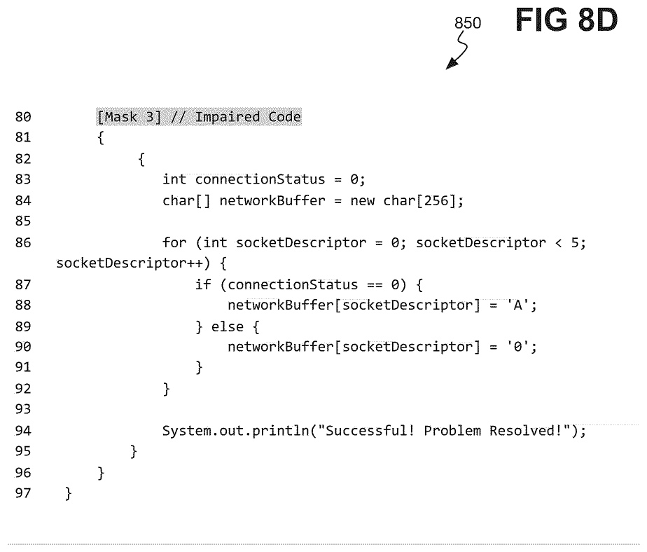

FIG. 8A shows an example flow graph 800 for an example structurally modifiable outer code variant-injected code section. The graph 800 includes nodes 802A, 802B, and 802C that respectively correspond to control statements to permit selection of the code variant-injected unsafe code section C′_{unsafe}, the code variant-injected safe code section C′_{safe}, or the impaired code section C_{impaired} via first, second, and third masks, respectively.

The graph 800 includes nodes 802D, 802E, and 802F that respectively correspond to CFGs for the variant-injected unsafe section C′_{unsafe}, the variant-injected safe section C′_{safe}, and the impaired section C_{impaired}. The CFG for C′_{unsafe} can be the CFG 370 of FIG. 7A. Since the CFG 370 of FIG. 3C is the same for both C_{safe} and C_{unsafe}, the CFG for C′_{safe} can also be the CFG 370 of FIG. 7A.

The graph 800 includes edges 804A, 804B, and 804C that define containing relationships between the nodes 802A and 802D, between the nodes 802B and 802E, and between the nodes 802C and 802F, respectively. The graph 800 includes edges 804D and 804E that define following relationships from the node 802B to the node 802A and from the node 802A to the node 802C, respectively.

Just one of the control statements of the nodes 802A, 802B, and 802C evaluates as true if the structurally modifiable outer variant-injected section corresponding to the graph 800 were executed. This means that just one of the C′_{safe}, C′_{unsafe}, or C_{impaired} would be executed at runtime. Either C′_{safe}, C′_{unsafe}, or C_{impaired} is selected depending on whether the second, first, or third mask of its corresponding control statement is evaluated as true. (All three of C′_{safe}, C′_{unsafe}, and C_{impaired} are included in the generated test code, even though just one of them would actually be executed at runtime, intending to confuse a generative AI model that is to perform SAST on generated code including the outer section corresponding to the graph 800.)

FIGS. 8B, 8C, and 8D show an example structurally modifiable outer variant-injected code section 850 corresponding to the graph 800. FIG. 8B specifically shows a portion of the structurally modifiable outer variant-injected section 850 corresponding to the nodes 802B and 802E and the edge 804B of FIG. 8A. Line 4 corresponds to the control statement of node 802B, lines 5 and 42 correspond to the edge 804B, and lines 6-41 correspond to the node 802E.

FIG. 8C specifically shows a portion of the structurally modifiable outer variant-injected section 850 corresponding to the nodes 802A and 802D and the edge 804A of FIG. 8A. Line 43 corresponds to the control statement of node 802A, lines 44 and 79 correspond to the edge 804A, and lines 45-78 correspond to the node 802D. That line 43 of FIG. 8C follows line 42 of FIG. 8B corresponds to the edge 804D of FIG. 8A.

FIG. 8D specifically shows a portion of the structurally modifiable outer variant-injected section 850 corresponding to the nodes 802C and 802F and the edge 804C of FIG. 8A. Line 80 corresponds to the control statement of node 802C, lines 81 and 97 correspond to the edge 804C, and lines 82-96 correspond to the node 802F. That line 80 of FIG. 8D follows line 79 of FIG. 8C corresponds to the edge 804E of FIG. 8A.

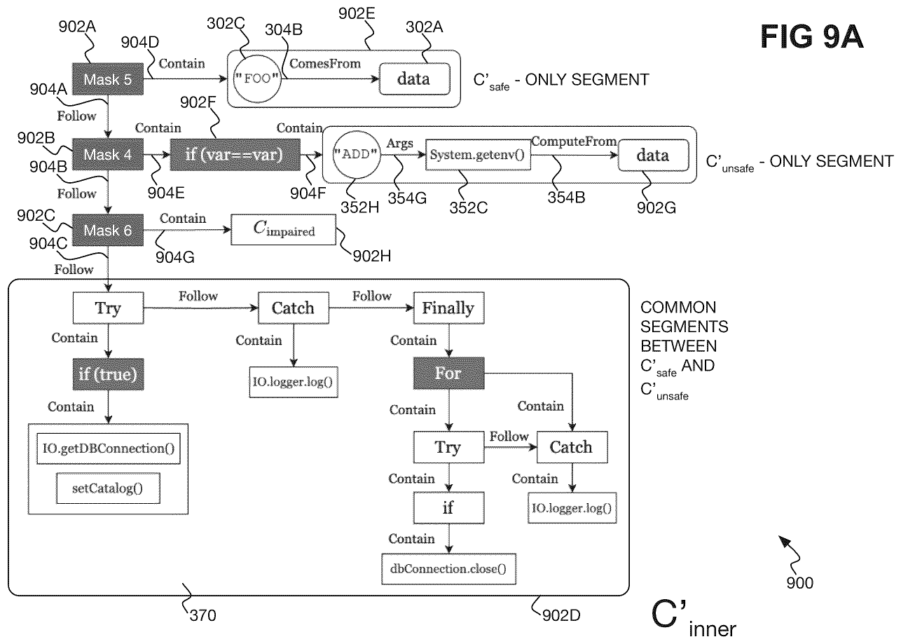

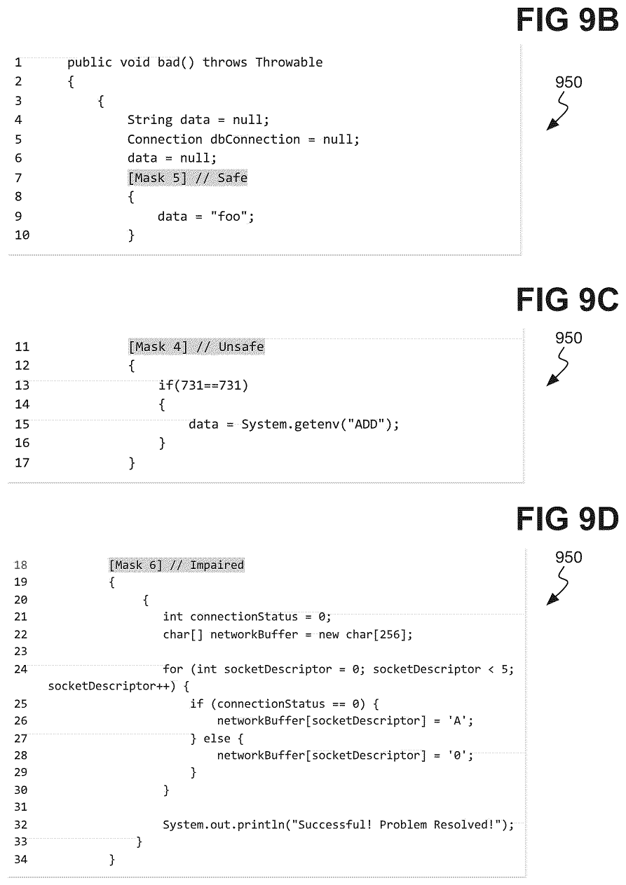

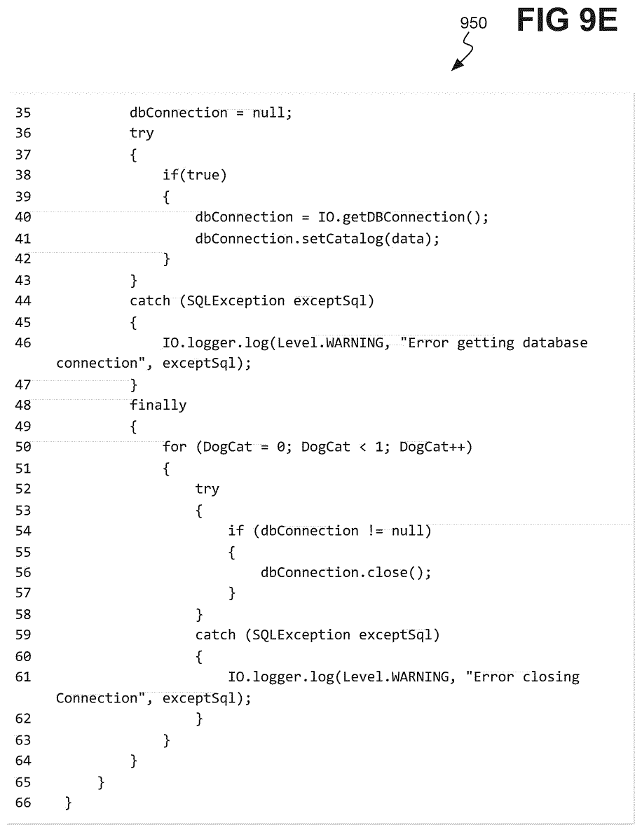

FIG. 9A shows an example flow graph 900 for an example structurally modifiable inner code variant-injected code section. The graph 900 includes nodes 902A, 902B, 902C, 902D, 902E, 902E, and 902F, and edges 904A, 904B, 904C, 904D, 904E, 904F, and 904G. The nodes 902A, 902B, and 902C respectively correspond to control statements to permit selection of a segment of the code variant-injected safe code section C′_{safe}, that has a corresponding but different segment in the code variant-injected unsafe code section C′_{unsafe}, the corresponding segment of the variant-injected unsafe section C′_{unsafe}, or the impaired code section C_{impaired} via fifth, fourth, and sixth masks, respectively.

The node 902H corresponds to the CFG of the impaired code section C_{impaired}, and thus is the node 802F of FIG. 8A. The node 902D corresponds to a CFG for the code section portion that is common to both the variant-injected safe section C′_{safe} and the variant-injected unsafe section C′_{unsafe}. Since the CFG 370 of FIG. 3C is the same for both C_{safe} and C_{unsafe}, the CFG of the node 902D can be the CFG 370 of FIG. 7A.

The nodes 902E and 902G, by comparison, correspond to a pair of differing, corresponding segments of the variant-injected safe section C′_{safe} and the variant-injected unsafe section C′_{unsafe}. For instance, the DFG 300 of FIG. 3A for C_{safe} has a segment including nodes 302A and 302C and edge 304B that differs from but which corresponds to the segment of the DFG 350 of FIG. 3B for C_{unsafe} that includes nodes 352A, 352C, and 352H and edges 354B and 354G.

Therefore, the node 902E corresponds the former segment, and the node 902G corresponds to the latter segment. The latter segment including the node 902G for C′_{unsafe} also includes the node 902F and the edge 904F defining a containing relationship between the node 902F and the node 902G. This is because the node 902G is actually for C′_{unsafe}—as opposed to for C_{unsafe}—and therefore the segment includes the node 702A and the edge 704B of FIG. 7A (i.e., the node 902B and the edge 904E in FIG. 9A).

The edges 904A, 904B, and 904C define following relationships between the nodes 902A and 902B, between the nodes 902B and 902C, and between the nodes 902C and 902D, respectively. The edges 904D, 904E, 904F, and 904G define containing relationships between the nodes 902A and 902E, between the nodes 902B and 902F, between the nodes 902F and 902G, and between the nodes between the nodes 902C and 902H.

Just one of the control statements of the nodes 902A, 902B, and 902C evaluates as true if the structurally modifiable inner variant-injected section corresponding to the graph 900 were executed. This means that just the segment in C′_{safe}, or the segment in C′_{unsafe}, or C_{impaired} would be executed at runtime. Either the segment of C′_{safe}, the segment of C′_{unsafe}, or C_{impaired} is selected depending on whether the fifth, fourth, or sixth mask of its corresponding control statement is evaluated as true.

However, the code portion that is common to both C′_{safe} and C′_{unsafe} is included (node 902D). This is why the structurally modifiable inner variant-injected section corresponding to the graph 900 of FIG. 9A is referred to as an inner such section, since a code section is internally altered via insertion of control statements in the code section. (By comparison, the structurally modifiable variant-injected section corresponding to the graph 800 of FIG. 8A is referred to as an outer such section, since code is altered via insertion of control statements outside the code sections.)

FIGS. 9B, 9C, 9D, and 9E show an example structurally modifiable inner variant-injected code section 950 corresponding to the graph 900. FIG. 9B specifically shows a portion of the structurally modifiable inner variant-injected section 950 corresponding to the nodes 902A and 902E and the edge 904D of FIG. 9A. Line 7 corresponds to the control statement of node 902A, lines 8 and 10 correspond to the edge 904D, and line 9 corresponds to the node 902E.

FIG. 9C specifically shows a portion of the structurally modifiable inner variant-injected section 950 corresponding to the nodes 902B, 902F, and 902G and the edges 904E and 904F of FIG. 9A. Line 11 corresponds to the control statement of node 902B, line 13 corresponds to the if( ) statement of node 902F, and line 15 corresponds to the node 902G. Lines 12 and 17 correspond to the edge 904E and lines 14 and 16 correspond to the edge 904F. That line 11 of FIG. 9C follows line 10 of FIG. 9B corresponds to the edge 904A of FIG. 9A.

FIG. 9D specifically shows a portion of the structurally modifiable inner variant-injected section 950 corresponding to the nodes 902C and 902H and the edge 904G of FIG. 9A. Line 18 corresponds to the control statement of node 902C, lines 19 and 34 correspond to the edge 904G, and lines 20-33 correspond to the node 902G. That line 18 of FIG. 9D follows line 17 of FIG. 9C corresponds to the edge 904B of FIG. 9A.

FIG. 9E specifically shows a portion of the structurally modifiable inner variant-injected section 950 corresponding to the node 902D. Lines 35-66 correspond to the node 902D. That line 35 of FIG. 9E follows line 34 of FIG. 9D corresponds to the edge 904C of FIG. 9A.

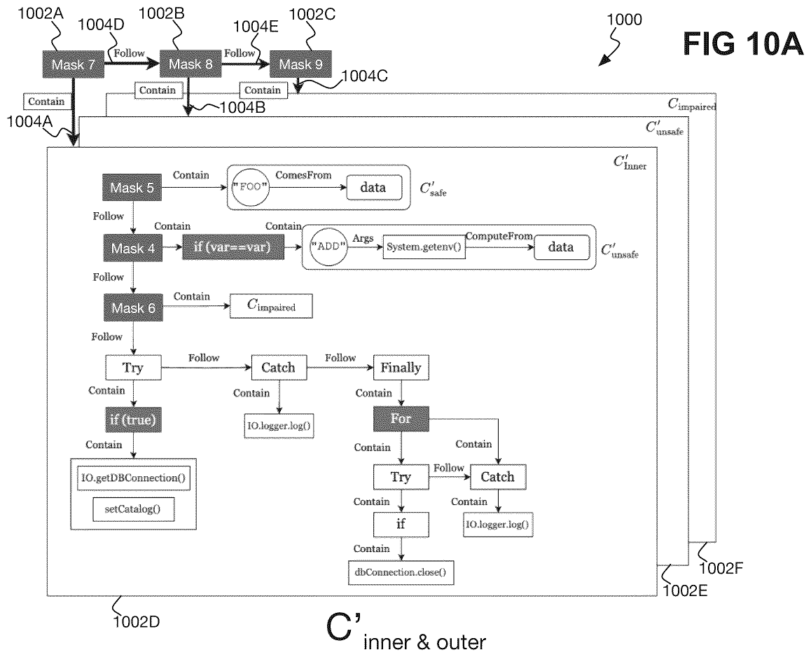

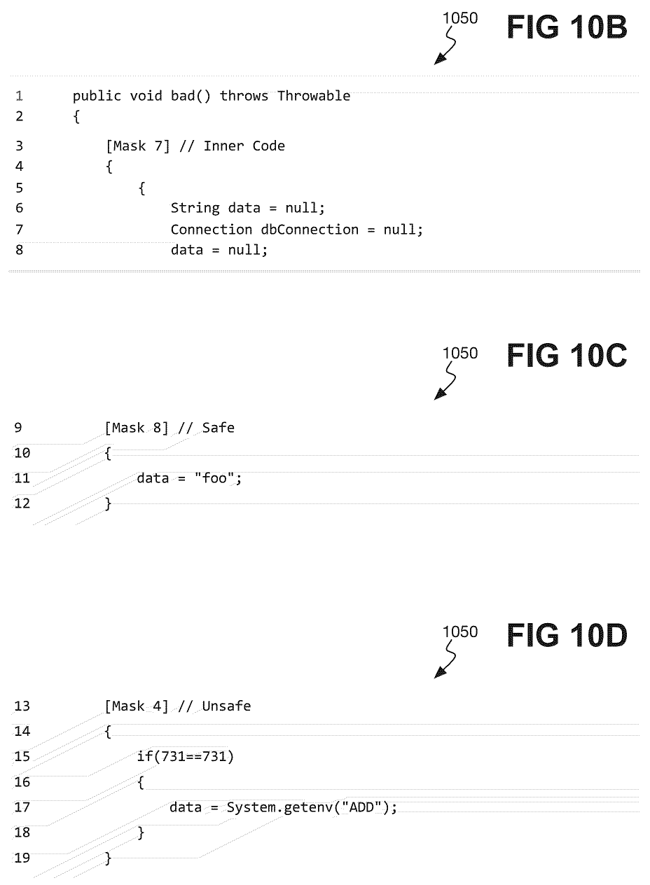

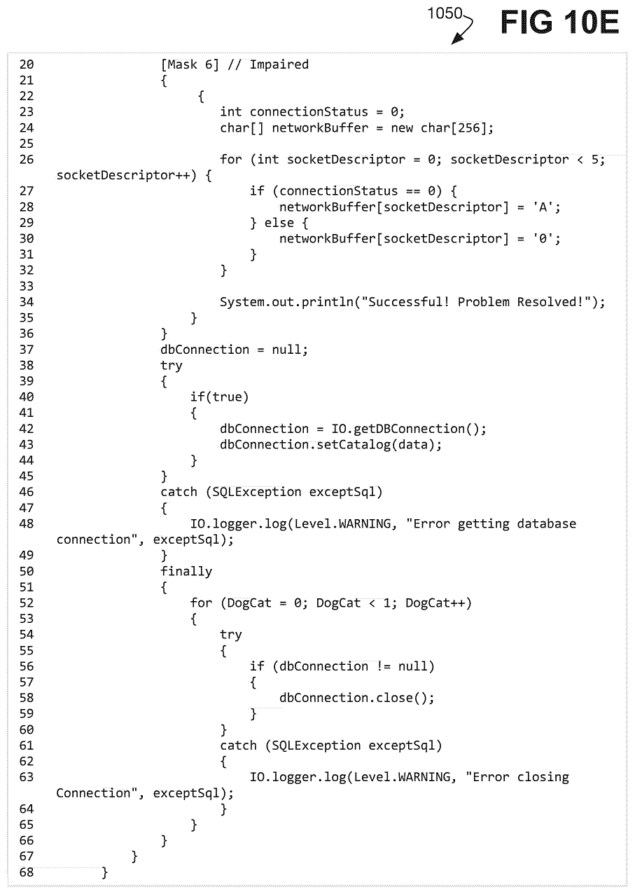

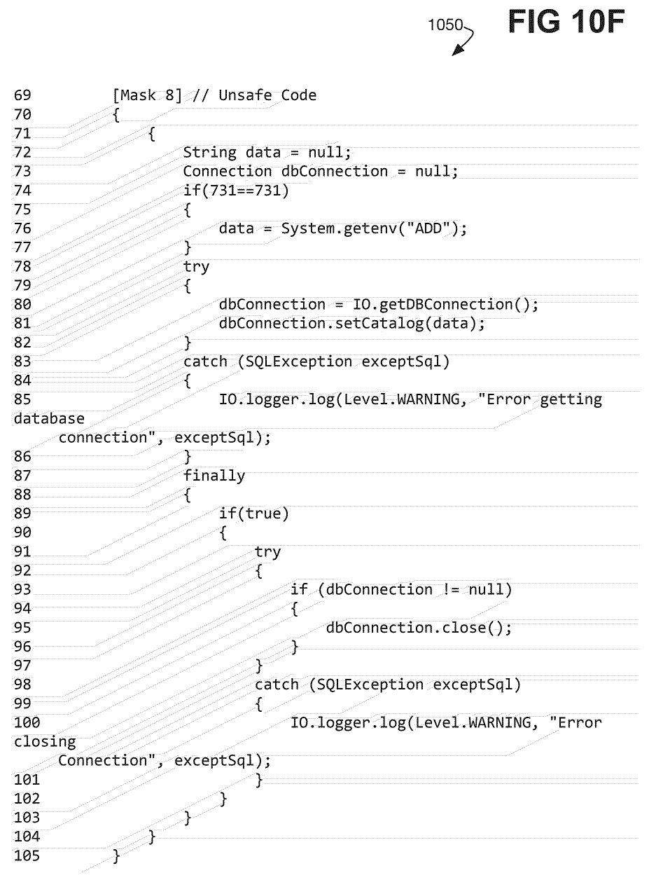

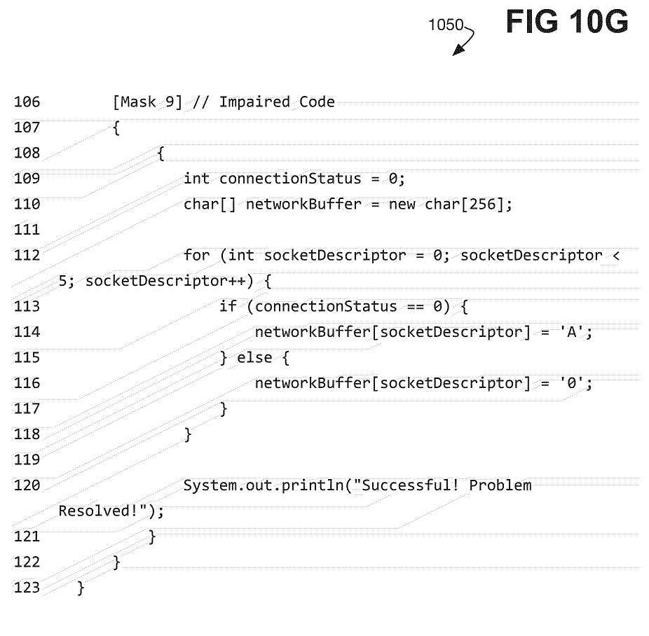

FIG. 10A shows an example flow graph 1000 for an example structurally modifiable inner-and-outer code variant-injected code section. The graph 1000 includes nodes 1002A, 1002B, and 1002C that respectively correspond to control statements to permit the outer selection of the inner code variant-injected code section C′ᵢₙₙₑᵣ, the code variant-injected unsafe code section C′_{unsafe}, or the impaired code section C_{impaired}, via seventh, eighth, and ninth masks, respectively.

The graph 1000 includes nodes 1002D, 1002E, and 1002F that respectively correspond to CFGs for the inner code variant-injected code section C′ᵢₙₙₑᵣ, the code variant-injected unsafe code section C′_{unsafe}, and the impaired code section C_{impaired}. The CFG for C′ᵢₙₙₑᵣ can be the graph 900 of FIG. 9A. The CFG for C′_{unsafe} can be the CFG 370 of FIG. 7A.

The graph 1000 includes edges 1004A, 1004B, and 1004C that define containing relationships between the nodes 1002A and 1002D, between the nodes 1002B and 1002E, and between the nodes 1002C and 1002F, respectively. The graph 1000 includes edges 1004D and 1004E that define following relationships from the node 1002A to the node 1002B and from the node 1002B to the node 1002C, respectively.

Just one of the control statements of the nodes 1002A, 1002B, and 1002C evaluates as true if the structurally modifiable inner-and-outer variant-injected section corresponding to the graph 1000 were executed. This means that just one of C′ᵢₙₙₑᵣ, C′_{unsafe}, or C_{impaired} would be executed at runtime. Either C′ᵢₙₙₑᵣ, C′_{unsafe}, or C_{impaired} is selected depending on whether seventh, eighth, or ninth mask of its corresponding control statement is evaluated as true.

FIGS. 10B, 10C, 10D, 10E, 10F, and 10G show an example structurally modifiable inner-and-outer variant-injected code section 1050 corresponding to the graph 1000. FIGS. 10B, 10C, 10D, and 10E specifically shows a portion of the structurally modifiable inner-and-outer variant-injected section 1050 corresponding to the nodes 1002A and 1002D.

Line 3 corresponds to the control statement of node 1002B, lines 4 and 68 correspond to the edge 1004A, and lines 5-67 correspond to the node 1002D. In the example, lines 5-67 in FIGS. 10B, 10C, 10D, and 10E are the same as lines 3-65 of FIGS. 9B, 9C, and 9D, since node 1002D is the graph 900 of FIG. 9A for the inner variant-injected code section C′ᵢₙₙₑᵣ.

FIG. 10F specifically shows a portion of the structurally modifiable inner-and-outer variant-injected section 1050 corresponding to the nodes 1002B and 1002E and the edge 1004B of FIG. 10A. Line 69 corresponds to the control statement of node 1002B, lines 70 and 105 correspond to the edge 1004B, and lines 71-104 correspond to the node 1002D. That line 69 of FIG. 10F follows line 68 of FIG. 10E corresponds to the edge 1004D of FIG. 10E.

FIG. 10G specifically shows a portion of the structurally modifiable inner-and-outer variant-injected section 1050 corresponding to the nodes 1002C and 1002F and the edge 1004C of FIG. 10A. Line 106 corresponds to the control statement of node 1002C, lines 107 and 121 correspond to the edge 1004C, and lines 108-120 correspond to the node 1002F. That line 106 of FIG. 10G follows line 105 of FIG. 10F corresponds to the edge 1004E of FIG. 10A.

Referring next to FIG. 1C, which is performed after FIG. 1B, a version 172 of provided test code 162 is generated (170) based on the structurally modifiable variant-injected code sections 134 and each provided behavior 166. The test code 162 is program code that the generated versions 172 thereof can be used as described later in the detailed description.

A behavior 166 generally specifies whether the resulting test code version 172 should be a safe behavior, an unsafe behavior, or an impaired behavior. The behavior 166 may therefore be referred to as xᵢ, which is selected from the set of X_{behavior}={x_{safe}, x_{unsafe}, and x_{impaired}}. Since there are multiple behaviors 166, such that multiple versions 172 of the test code 162 are generated.

The test code version 172 for a behavior 166 can be generated as follows. For a given structurally modifiable variant-injected code section 134, the test code 162 includes instances 164 of code sections that are substituted (i.e., replaced) based on that code section 134 in accordance with a behavior when generating the test code version 172 corresponding to the section 134.

For example, the test code 162 may have one or more code instances 164 that each correspond to the outer structure code section 134A of FIG. 1B, one or more instances 164 that each correspond to the inner structure code section 134B, and/or one or more instances 164 that each correspond to the inner-and-outer structure code section 134C. The instances 164 corresponding to the outer section 134A are each replaced by the section 134A in accordance with the behavior 166 to generate corresponding substituted instances 174 of the test code version 172 in question.

Similarly, the instances 164 corresponding to the inner code section 134B are each replaced by the section 134B in accordance with the behavior 166 to generate corresponding substituted instances 174 of the test code version 172, and the instances 164 corresponding to the inner-and-outer code section 134C are each replaced by the section 134C in accordance with the behavior 166 to generate corresponding substituted instances 174.

Stated another way, to generate a substituted instance 174 of a test code version 172, the corresponding variant-injected section 134A, 134B, or 134C is evaluated according to the behavior 166. The instance 174 is effectively the variant-injection section 134A, 134B, or 134C after it has been structurally modified per the behavior 166.

Generation of the test code version 172 further includes effectively infilling the masked control statements 136A, 136B, and 136C within their respective code sections 134A, 134B, and 134C based on mask values 168 that are specified based on the behavior 166. This is achieved by setting the masks 138A, 138B, and 138C with values 168 as is now described.

Specifically, as a concrete example as to the outer code section 134A in relation to C′ₒᵤₜₑᵣ of FIG. 8A, if xᵢ is x_{safe}, then the control statements 136A in C′ₒᵤₜₑᵣ are infilled with values 168 for the masks 138A so that just the variant-injected safe code section 122A within the section 134A would be executed at runtime. If xᵢ is x_{unsafe}, then the control statement 136A in C′ₒᵤₜₑᵣ are infilled with values 168 for the masks 138A so that just the variant-injected unsafe code section 122B would be executed at runtime. If xᵢ is x_{impaired}, then the control statement 136A in C′ₒᵤₜₑᵣ are infilled with values 168 for the masks 138A so that just the impaired code section 132 would be executed at runtime.

As a concrete example as to the inner code section 134B in relation to C′ᵢₙₙₑᵣ of FIG. 9A, if xᵢ is x_{safe}, then the control statements 136B in C′ᵢₙₙₑᵣ are infilled with values 168 for the masks 138B so that just a segment of the variant-injected safe section 122A would be executed at runtime. If xᵢ is x_{unsafe}, then the control statements 136B in C′ᵢₙₙₑᵣ are infilled with values 168 for the masks 138B so that just a corresponding, differing segment of the variant-injected unsafe section 122B would be executed at runtime. If xᵢ is x_{impaired}, then the control statement 136B in C′ᵢₙₙₑᵣ are infilled with values 168 for the masks 138B so that just the impaired section 132 would be executed at runtime.

As a concrete example as to the inner-and-outer code section 134C in relation to C′_{inner&outer} of FIG. 10A, if xᵢ is x_{safe}, then the control statements 136C in C′_{inner&outer} are infilled with values 168 for the masks 138C so that just the variant-injected safe code section 122A is selected within the section 134C. If xᵢ is x_{unsafe}, then the control statements 136C in C′_{inner&outer} are infilled with values for the masks 138C so that just the inner code section 134B would be executed at runtime (e.g., similar to the previous paragraph). If xᵢ is x_{impaired}, then the control statements 136C in C′_{inner&outer} are infilled with values for the masks 138C so that just the impaired code section 132 would be executed at runtime.

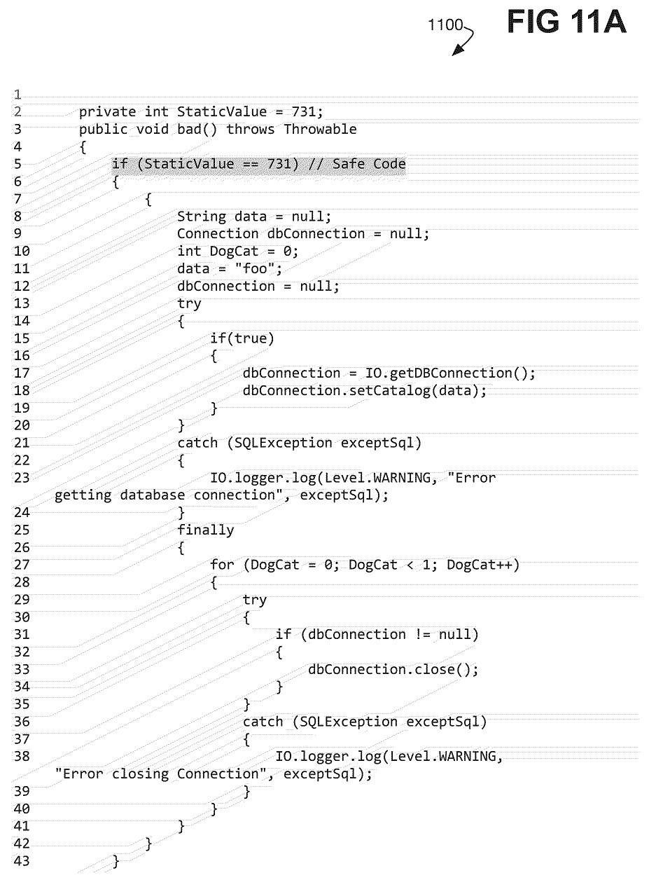

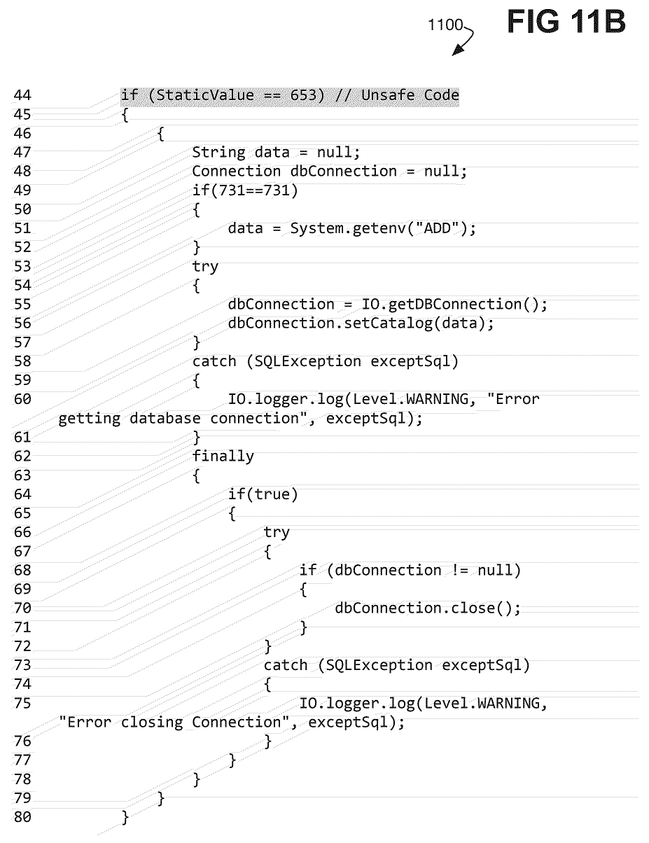

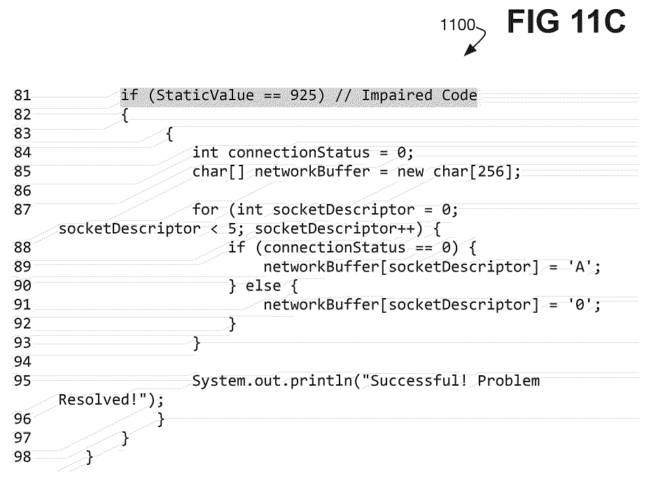

FIGS. 11A, 11B, and 11C show an example test code version 1100 generated by structurally modifying the structurally modifiable outer variant-injected code section 850 of FIGS. 8B-8D in accordance with a specified behavior. Test code versions can also be generated by structurally modifying the structurally modifiable inner and inner-and-outer variant-injected code sections 950 and 1050 of FIGS. 9B-9E and 10B-10G.

The test code version 1100 has been generated by infilling the structurally modifiable outer variant-inject section 850 of FIGS. 8B, 8C, and 8D with a mask value 731 in the control statements of lines 4, 43, and 80 of the section 850. This is achieved in the test code version 1100 by adding setting the global variable StaticValue to 731 in line 2 of the test code version 1100 in FIG. 11A.

Therefore, lines 6-42 of the test code version 1100 in FIG. 11B, which constitute a variant-injected safe code section, are actually performed. This is because the control statement of line 5 for the variant-injected safe code section evaluates as true when StaticValue is equal to 731.

By comparison, lines 45-80 in FIG. 11B, which constitute a variant-injected unsafe section, are not performed, since their respective control statement in line 44 does not evaluate as true when StaticValue is equal to 731. Similarly, lines 82-97 in FIGS. 11B and 11C, which constitute an impaired code section, are not performed, since their respective control statement in line 81 does not evaluate as true when StaticValue is equal to 731.

Referring back to FIG. 1C, the generated test code versions 172 are narrowed down (176) to just those that are actually compilable, as compilable test code versions 178. That is, each test code version 172 may be compiled to validate that compilation occurs without error. This ensures that the remaining compilable test code versions 178 are fully functional.

FIGS. 1D and 1E respectively show example processes 180 and 190 for using the test code version 178 generated in FIG. 1C. The processes 180 and 190 may be implemented as program code stored on a non-transitory computer-readable data storage medium. The program code that may implement the processes 180 and 190 is different than the target code referenced in these figures.

In FIG. 1D, the test code version 178 can be used to train (183) a generative AI model 182 for performing SAST, yielding a trained generative AI model 182′. The model 182 may be an LLM. LLM examples include GPT-5 or newer (available from OpenAI, Inc.); Claude 4 Sonnet or Opus or newer (available from Anthropic PBC); Gemini Pro 1.5 or Ultra or newer (available from Google LLC); and Llama 3 Instruct or newer (open source, available from Meta Platforms Inc.).

Training the AI model 182 using the test code version 178 improves vulnerability identification accuracy when the trained model 182′ is used to evaluate target program code 185. The target code 185 (e.g., a representation thereof) can thus be input to the model 182′ to perform SAST (184) to identify security vulnerabilities 186 within the code 185.

Remedial actions regarding the target code 185 can then be performed (187) to resolve (including at least lessening the impact of) their impact. For example, for some types of vulnerabilities 186, the code 185 may be automatically modified to remove them. Therefore, ultimate execution after compilation of the code 185 will not result in the vulnerabilities 186 occurring, such that code execution is more secure.

In FIG. 1E, the test code version 178 can be used to evaluate (191) a SAST technique 192. Evaluation involves performing SAST on the test code version 178 using the SAST technique 192, which results in detected security vulnerabilities or AI model responses 193. The SAST technique may include a generative AI model-based technique, a non-generative AI model-based technique (e.g., a compiler-based approach, a rule-based approach, and so on), or a hybrid technique including elements of both a generative AI model-based technique and a non-generative AI model technique.

The detected security vulnerabilities or AI model responses 193 are compared (195) against expected detection results 196, yielding comparison results 197. That is, the test code version 178 constitutes a benchmark used to evaluate the SAST technique 192. The expected detection results 196 are those that the SAST technique 192 should have detected or reported, whereas the detected vulnerabilities or AI model responses 193 are those that the SAST technique 192 actually did detect or report.

Typical measurements used during comparison (195) include true positive rates (TPR), false positive rates (FPR), true negative rates (TNR), false negative rate (FNR), accuracy, precision, recall, and F1 score. Furthermore, when the SAST technique 192 is an AI-based approach, or hybrid-AI approach, additional measurements used during evaluation may also include structure reasoning around data flow and control flow, semantic reasoning around counterfactual, goal-driven, and predictive scenarios, as well as consistency score.

The SAST technique 192 can then be modified (194) based on the comparison results 197, to yield a modified SAST technique 192′ that improves the technique 192. Similar to in FIG. 1D, the modified SAST technique 192′ can then be used to perform SAST (184) to identify security vulnerabilities 186 within the code 185, with remedial actions thereafter performed (187) to resolve them.

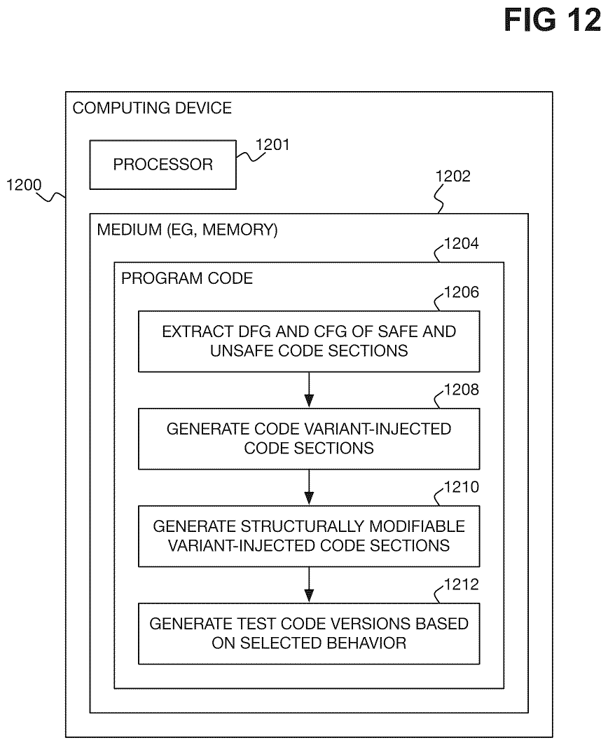

FIG. 12 shows an example computing device 1200. The computing device 1200 is more generally a computing system that can include multiple discrete computing devices. The computing device 1200 includes a processor 1201 and a memory 1202. The memory 1202 is more generally a non-transitory computer-readable data storage medium, and stores program code 1204 executable by the processor 1201 to perform processing, such as that of FIGS. 1A-1D as has been described, to realize a method.

For instance, the processing can include extracting a DFG 106A and a CFG 104A for a safe code section 102A and a DFG 106B and a CFG 104B for an unsafe code section 102B corresponding to the safe code section 102A (1206). The processing can include generating code variant-injected safe code sections 122A corresponding to the safe code section 102A in which code semantics are not altered, as well as code variant-injected unsafe code sections 122B corresponding to the unsafe code section 102B in which code semantics are not altered (1208).

The processing can include generating structurally modifiable code variant-injected code sections 134 (1210), based on the variant-injected safe sections 122A, the variant-injected unsafe sections 122B, and an impaired code section 132 that is semantically uncorrelated to the code variant-injected safe and unsafe code sections 122A and 122B. The processing can include respectively generating a version 172 of test code 162 based on the structurally modifiable variant-injected sections 134 and a specified behavior (1212).

We claim:

1. A non-transitory computer-readable data storage medium storing program code executable by a processor to perform processing comprising:
extracting a data flow graph and a control flow graph of each of a safe code section and an unsafe code section corresponding to the safe code section;
generating a plurality of code variant-injected safe code sections corresponding to the safe code section and a plurality of code variant-injected unsafe code sections, in which code semantics are not altered;
generating a plurality of structurally modifiable code variant-injected code sections based on the code variant-injected safe code sections, the code variant-injected unsafe code sections, and an impaired code section semantically uncorrelated to the code variant-injected safe code section and the code variant-injected unsafe code section; and
generating a version of test code based on the structurally modifiable variant-injected code sections and based on a specified behavior.

2. The non-transitory computer-readable data storage medium of claim 1, wherein the processing further comprises:
training a generative artificial intelligence (AI) model for security application security testing (SAST) using the generated version of test code.

3. The non-transitory computer-readable data storage medium of claim 2, wherein the processing further comprises:
performing SAST on target code using the trained generative AI model, to identify security vulnerabilities within the target code,
wherein training the generative AI model for SAST using the versions of the target code improves identification of the security vulnerabilities within the target code.

4. The non-transitory computer-readable data storage medium of claim 3, wherein the processing further comprises:
performing a remedial action regarding the target code to resolve the security vulnerabilities that have been identified.

5. The non-transitory computer-readable data storage medium of claim 1, wherein the processing further comprises:
evaluating a SAST technique using the generated version of test code for the SAST technique;
comparing evaluation results against expected results;
modifying the SAST technique to improve the SAST technique; and
performing SAST on target code using the modified SAST technique, to identify security vulnerabilities within the target code.

6. The non-transitory computer-readable data storage medium of claim 5, wherein the processing further comprises:
performing a remedial action regarding the target code to resolve the security vulnerabilities that have been identified.

7. The non-transitory computer-readable data storage medium of claim 5, wherein the processing further comprises:
performing a remedial action regarding the target code to resolve the security vulnerabilities that have been identified.

8. The non-transitory computer-readable data storage medium of claim 1, wherein the data flow graph comprises a plurality of first nodes of the code section and a plurality of edges representing data dependencies among the first nodes within the code section, and
wherein the control flow graph comprises a plurality of second code nodes of the code section and a plurality of edges representing control flows among the second nodes within the code section.

9. The non-transitory computer-readable data storage medium of claim 1, wherein generating the code variant-injected safe code sections corresponding to the safe code section and generating the code variant-injected safe code sections corresponding to the unsafe code section comprises:
identifying, based on the data flow graph and the control flow graph, a plurality of potential areas in which code variants are to be injected;
narrowing down the potential areas to yield narrowed-down potential areas that, when injected with the code variants, do not alter code semantics;
selecting, from the narrowed-down potential areas, target areas within the code section in which the code variants are to be injected; and
injecting the code variants into the target areas.

10. The non-transitory computer-readable data storage medium of claim 1, wherein the structurally modifiable code variant-injected code sections comprise, for a code variant-injected safe code section and a code variant-injected unsafe code section:
a structurally modifiable outer code variant-injected code section comprising, for a segment of the code variant-injected safe code section and a corresponding segment of the code variant-injected unsafe code section are semantically distinct:
a first control statement outside the corresponding segment of the code variant-injected unsafe code section for selection via a first mask;
a second control statement outside the segment of the code variant-injected safe code section for selection via a second mask; and
a third control statement outside the impaired code section for selection by a third mask.

11. The non-transitory computer-readable data storage medium of claim 10, wherein generating the version of the test code comprises:
substituting a corresponding instance of a code section in the test code with the structurally modifiable outer code variant-injected code section based on values for the first, second, and third masks specified by the behavior.

12. The non-transitory computer-readable data storage medium of claim 10, wherein the structurally modifiable code variant-injected code sections further comprise, for the code variant-injected safe code section and the code variant-injected unsafe code section:
a structurally modifiable inner code variant-injected code section comprising:
a fourth control statement for selection of a segment of the code variant-injected unsafe code section for which the code variant-injected safe code section has a corresponding, different segment, via a fourth mask;
a fifth control statement for selection of the corresponding, different segment of the variant-injected safe code section, via a fifth mask; and
a sixth control statement for selection via a sixth mask.

13. The non-transitory computer-readable data storage medium of claim 12, wherein generating the version of the test code comprises:
substituting a corresponding instance of a code section in the test code with the structurally modifiable outer code variant-injected code section based on values for the first, second, and third masks specified by the behavior; and
substituting a corresponding instance of a code section in the test program with the structurally modifiable inner code variant-injected code section based on values for the fourth, fifth, and sixth masks specified by the behavior.

14. The non-transitory computer-readable data storage medium of claim 12, wherein the structurally modifiable code variant-injected code sections further comprise, for the code variant-injected safe code sections and one of the code variant-injected unsafe code sections:
a structurally modifiable outer-and-inner code variant-injected code section comprising:
a seventh control statement outside the structurally modifiable inner code variant-injected code section for selection via a seventh mask,
an eighth control statement outside the segment of the code variant-injected safe code section for selection via an eighth mask, and
a ninth control statement outside the corresponding segment of the impaired code section for selection by a ninth mask.

15. The non-transitory computer-readable data storage medium of claim 14, wherein generating the version of the test code comprises:
substituting a corresponding instance of a code section in the test code with the structurally modifiable outer code variant-injected code section based on values for the first, second, and third masks specified by the behavior;
substituting a corresponding instance of a code section in the test code with the structurally modifiable inner code variant-injected code section based on values for the fourth, fifth, and sixth masks specified by the behavior; and
substituting a corresponding instance of a code section in the test code with the structurally modifiable inner code variant-injected code section based on values for the seventh, eighth, and ninth masks specified by the behavior.

16. The non-transitory computer-readable data storage medium of claim 1, wherein the processing further comprises:
narrowing down versions of the test code generated based on different specified behaviors to yield narrowed-down versions of the test code that are actually compilable.

17. A computing device comprising:
a processor; and
a memory storing instructions executable by the processor to perform processing comprising:
extracting a data flow graph and a control flow graph of each of a safe code section and an unsafe code section corresponding to the safe code section;
generating a plurality of code variant-injected safe code sections corresponding to the safe code section and a plurality of code variant-injected unsafe code sections, by:
identifying, based on the data flow graph and the control flow graph, a plurality of potential areas in which code variants are to be injected;
narrowing down the potential areas to yield narrowed-down potential areas that, when injected with the code variants, do not alter code semantics;
selecting, from the narrowed-down potential areas, target areas within the code section in which the code variants are to be injected; and
injecting the code variants into the target areas;
generating a plurality of structurally modifiable code variant-injected code sections based on the code variant-injected safe code sections, the code variant-injected unsafe code sections, and an impaired code section semantically uncorrelated to the code variant-injected safe code section and the code variant-injected unsafe code section;
generating versions of test code based on the structurally modifiable variant-injected code sections and based on specified behaviors; and
narrowing down the versions of the test code to yield narrowed-down versions of the test code that are actually compilable.

18. A method performed by a processor and comprising:
extracting, by a processor, a data flow graph and a control flow graph of each of a safe code section and an unsafe code section corresponding to the safe code section;
generating, by the processor, a plurality of code variant-injected safe code sections corresponding to the safe code section and a plurality of code variant-injected unsafe code sections corresponding to the unsafe code section, in which code semantics are not altered;
generating, by the processor, a plurality of structurally modifiable code variant-injected code sections based on the code variant-injected safe code sections, the code variant-injected unsafe code sections, and an impaired code section semantically uncorrelated to the code variant-injected safe code section and the code variant-injected unsafe code section; and
generating, by the processor, a version of test code based on the structurally modifiable variant-injected code sections and based on a specified behavior,
wherein the structurally modifiable code variant-injected code sections comprise, for a code variant-injected safe code section and a code variant-injected unsafe code section:
a structurally modifiable outer code variant-injected code section comprising, for a segment of the code variant-injected safe code section and a corresponding segment of the code variant-injected unsafe code section are semantically distinct:
a first control statement to permit selection of the corresponding segment of the code variant-injected unsafe code section via a first mask;
a second control statement to permit selection of the segment of the code variant-injected safe code section via a second mask; and
a third control statement to permit selection of the impaired code section by a third mask;
a structurally modifiable inner code variant-injected code section comprising:
a fourth control statement for selection of a segment of the code variant-injected unsafe code section for which the code variant-injected safe code section has a corresponding, different segment, via a fourth mask;
a fifth control statement for selection of the corresponding, different segment of the variant-injected safe code section, via a fifth mask; and
a sixth control statement for selection via a sixth mask.

19. The method of claim 18, wherein the structurally modifiable code variant-injected code sections further comprise, for the code variant-injected safe code sections and one of the code variant-injected unsafe code sections:
a structurally modifiable outer-and-inner code variant-injected code section comprising:
a seventh control statement outside the structurally modifiable inner code variant-injected code section for selection via a seventh mask,
an eighth control statement outside the segment of the code variant-injected safe code section for selection via an eighth mask, and
a ninth control statement outside the corresponding segment of the impaired code section for selection by a ninth mask.

20. The method of claim 19, wherein generating the version of the test code comprises:
substituting a corresponding instance of a code section in the test code with the structurally modifiable outer code variant-injected code section based on values for the first, second, and third masks specified by the behavior;
substituting a corresponding instance of a code section in the test code with the structurally modifiable inner code variant-injected code section based on values for the fourth, fifth, and sixth masks specified by the behavior; and
substituting a corresponding instance of a code section in the test code with the structurally modifiable inner code variant-injected code section based on values for the seventh, eighth, and ninth masks specified by the behavior.
